(19) United States
(12) Patent Application Publication
(10) Pub. No.: US 2026/0204970 A1
(43) Pub. Date: Jul. 16, 2026

(54) STATOR FOR AN ELECTRIC MACHINE

(71) Applicant: Valeo eAutomotive Germany GmbH, Erlangen (DE)

(72) Inventors: Boris DOTZ, Erlangen (DE); Carsten SIEPKER, Erlangen (DE)

(73) Assignee: Valeo eAutomotive Germany GmbH, Erlangen (DE)

(21) Appl. No.: 19/136,357

(22) PCT Filed: Dec. 13, 2023
(86) PCT No.: PCT/EP2023/085587

§ 371 Date: Jun. 6, 2025

(30) Foreign Application Priority Data
Dec. 15, 2022 (DE) 10 2022 133 495.3

(51) Int. Cl. H02K 3/28

(52) U.S. Cl. CPC H02K 3/28

(57) ABSTRACT

A stator for an electric machine includes a stator core and a stator winding which has N strands. Each strand is formed by shaped conductors which have leg portions and form connecting portions, which connect in each case two of the leg portions, at the end sides. The stator winding has, for each strand, at least one current path formed from series connection of a plurality of leg portions and in which a last leg portion of a first current path portion and a first leg portion of a second current path portion are arranged in a reference layer which is a first layer or an L-th layer of an associated slot, a last leg portion of the second current path portion and a first leg portion of a third current path portion are arranged in the other layer, and outer leg portions of the current path are arranged in a double layer having the reference layer.

The present invention relates to a stator for an electric machine.

Stators in which strands of a stator winding are each formed by shaped conductors have become the focus of industrial development efforts, in particular in the automotive engineering sector. Here, the shaped conductors have leg portions, and, at end sides of a stator core, form connecting portions by which in each case two of the leg portions are electrically conductively connected to one another.

Current paths of each one of the strands are often formed in accordance with a winding pattern that exhibits a reversal of the winding direction in the circumferential direction. For example, DE 10 2017 210 132 A1 discloses a stator arrangement for an electric machine having a cylindrical stator body. The stator body has adjacent plug-in locations, windings and plug-in elements for current reversal, said plug-in elements being inserted into the plug-in locations. The plug-in elements have two portions and a U-shaped further portion connecting the two portions, and are connected to the windings.

A disadvantage of this is that connecting portions that implement the reversal of the winding direction are arranged on the end side of the stator core, where the outer leg portions of the current path also project out of the stator core. Connections for the strands, and the connecting portions which are provided for the reversal of the winding direction and which are normally of more complex design than the other connecting portions, then both have to be accommodated on the same end side.

One possible embodiment in which this arrangement is particularly disadvantageous is one in which the connections are to be arranged on that end side on which the connecting portions are formed by electrical and mechanical contacting of the shaped conductors. This is because it is very complex from a manufacturing aspect to form connecting portions suitable for the reversal of the winding direction by contacting two shaped conductors.

The object of the invention is therefore to provide a manufacturing-friendly option for providing a stator having a stator winding, the at least one current path of which exhibits a reversal of the winding direction.

Said object is achieved according to the invention by means of a stator for an electric machine, the stator comprising a stator core which has a longitudinal axis, a first end side, a second end side situated opposite the first end side, and a plurality of slots extending from the first end side to the second end side, and the stator comprising a stator winding which has a number N of strands, wherein N≥2, wherein a first circumferential direction and a second circumferential direction that is opposite to the first circumferential direction are defined in relation to the longitudinal axis, wherein each strand is formed by shaped conductors which have leg portions arranged within the slots and form connecting portions which electrically conductively connect in each case two of the leg portions to one another at the end sides, wherein the slots form, for each strand, a plurality of winding zones, and each slot is subdivided radially into first to L-th layers, which are named according to their order in the radial direction, and L/2 double layers of radially immediately adjacent layers, wherein L≥2 and is an even number, wherein the stator winding has, for each strand, at least one current path, which is formed from a plurality of the leg portions and a plurality of connecting portions which interconnect the leg portions to form a series connection, wherein the at least one current path has a first outer leg portion in relation to the series connection and has a second outer leg portion that is situated opposite the first outer leg portion in relation to the series connection, wherein the at least one current path has a first current path portion, which comprises the first outer leg portion and one leg portion or a plurality of leg portions which are successive in terms of the series connection, and has a second current path portion and a third current path portion, which each comprise a plurality of leg portions which are successive in terms of the series connection, wherein a last of the leg portions of the first current path portion is connected by means of one of the connecting portions directly to a first of the leg portions of the second current path portion, and a last of the leg portions of the second current path portion is connected by means of one of the connecting portions directly to a first of the leg portions of the third current path portion, wherein the last leg portion of the first current path portion and the first current path portion of the second current path portion of the at least one current path are arranged in a reference layer which is one out of the first layer and the L-th layer, and the last leg portion of the second current path portion and the first leg portion of the third current path portion of the at least one current path are arranged in the other out of the first layer and the L-th layer, wherein the outer leg portions of the at least one current path are arranged in that double layer which comprises the reference layer, wherein the leg portions of the second current path portion occupy immediately adjacent winding zones of the same strand from the first to the last leg portion of the second current path portion along one of the circumferential directions as reference direction, and the leg portions of the third current path portion occupy immediately adjacent winding zones of the same strand proceeding from the first leg portion of the third current path portion along that circumferential direction which is opposite to the reference direction, wherein one current path is formed as a current path of a first type, in which the reference layer is the first layer and the reference direction is the first circumferential direction.

The stator according to the invention for an electric machine has a stator core. The stator core has a longitudinal axis, a first end side, a second end side and a plurality of slots. The second end side is situated opposite the first end side. The slots extend from the first end side to the second end side. The stator furthermore has a stator winding. The stator winding has a number N of strands, wherein N≥2. A first circumferential direction and a second circumferential direction are defined in relation to the longitudinal axis. The second circumferential direction is opposite to the first circumferential direction. Each strand is formed by shaped conductors. The shaped conductors have leg portions arranged within the slots. The shaped conductors form connecting portions. The connecting portions electrically conductively connect in each case two of the leg portions to one another at the end sides. The slots form, for each strand, a plurality of winding zones. Each slot is subdivided radially into first to L-th layers. The layers are named according to their order in the radial direction. Each slot is furthermore subdivided into L/2 double layers of radially immediately adjacent layers, wherein L≥2 and is an even number. The stator winding has, for each strand, at least one current path. The at least one current path is formed from a plurality of the leg portions and a plurality of connecting portions which interconnect the leg portions to form a series connection. The at least one current path has a first outer leg portion in relation to the series connection and has a second outer leg portion. The second outer leg portion is situated opposite the first outer leg portion in relation to the series connection. The at least one current path has a first current path portion, a second current path portion and a third current path portion. The first current path portion comprises the first outer leg portion. The first current path portion comprises one leg portion or a plurality of leg portions which are successive in terms of the series connection. The second current path portion and the third current path portion each comprise a plurality of leg portions which are successive in terms of the series connection. A last of the leg portions of the first current path portion is connected by means of one of the connecting portions directly to a first of the leg portions of the second current path portion. A last of the leg portions of the second current path portion is connected by means of one of the connecting portions directly to a first of the leg portions of the third current path portion. The last leg portion of the first current path portion and the first leg portion of the second current path portion of the at least one current path are arranged in a reference layer. The reference layer is one out of the first layer and the L-th layer. The outer leg portions of the at least one current path are arranged in that double layer which comprises the reference layer. The last leg portion of the second current path portion and the first leg portion of the third current path portion of the at least one current path are arranged in the other out of the first layer and the L-th layer. The leg portions of the second current path portion occupy immediately adjacent winding zones of the same strand from the first to the last leg portion of the second current path portion along one of the circumferential directions as reference direction. The leg portions of the third current path portion occupy immediately adjacent winding zones of the same strand proceeding from the first leg portion of the third current path portion along that circumferential direction which is opposite to the reference direction. One current path is formed as a current path of a first type. In the current path of the first type, the reference layer is the first layer. In the current path of the first type, the reference direction is the first circumferential direction.

In the stator according to the invention, aside from the second current path portion and the third current path portion, which occupy the immediately adjacent winding zones along different circumferential directions and thus occupy a reversal of the winding direction, the first current path portion is provided, the last leg portion of which is arranged in the same layer as the first leg portion of the second current path portion. The position of the connecting portion that connects the last leg portion of the second current path portion to the first leg portion of the third current path portion can thus be varied along the series connection, and a position of said connecting portion that is advantageous in terms of manufacturing can thus be specified.

It is particularly advantageously the case that, in the stator according to the invention, the last leg portion of the first current path portion and the first leg portion of the second current path portion, on the one hand, and the last leg portion of the second current path portion and the first leg portion of the third current path portion, on the other hand, are arranged radially opposite one another in the first and the L-th layer. This makes it easier to configure the shaped conductors that form these leg portions, because they are surrounded radially only on one side by other shaped conductors. This makes it possible to provide a space-saving configuration of winding heads of the stator.

The stator core is in particular formed from a plurality of individual laminations that are axially layered and/or electrically insulated from one another. In this respect, the stator core can also be regarded or referred to as a stator laminated core. The slots typically extend axially within the stator core.

The shaped conductors have, in particular, a rectangular cross section. The shaped conductors are in particular solid, preferably non-flexible, electrical conductors composed of a metal, preferably copper. The shaped conductors may be bent U-pins, which form two leg portions, or I-pins, which form one leg portion.

The number of strands is preferably exactly three or exactly six. The strands may be inter-connected as a star connection or as a delta connection.

The number of layers is preferably at most sixteen, particularly preferably at most twelve. In preferred embodiments, L is exactly equal to six or exactly equal to eight or exactly equal to ten. The first layer may be the radially outermost or the radially innermost of the layers.

Preferably, each winding zone receives the leg portions which, for one of the strands, form a pole of the stator winding. The number of winding zones for each one of the strands may correspond to the number of poles of the stator winding. The number of poles is preferably at most sixteen, particularly preferably at most twelve. In a preferred embodiment, the number of poles is exactly equal to four or exactly equal to six or exactly equal to eight or exactly equal to ten.

According to the invention, the first current path portion may comprise either one leg portion or a plurality of leg portions. If the first current path portion comprises only one leg portion, the first outer leg portion of the at least one current path is at the same time the last leg portion of the first current path portion of the at least one current path. The third current path portion may comprise the second outer leg portion as last leg portion.

In general, provision may be made for each current path portion of the at least one current path to form a wave winding. Furthermore, the outer leg portions may be the first and last leg portions, in relation to the series connection, of the at least one current path.

The first circumferential direction may be clockwise or counterclockwise when viewing the first end side. The terms “first circumferential direction” and “second circumferential direction” may also be regarded or referred to as opposite first and second orientations of a circumferential direction about the longitudinal axis.

In a preferred embodiment, the last leg portion of the first current path portion and the first leg portion of the second current path portion are formed by the same shaped conductor. Alternatively or in addition, the last leg portion of the second current path portion and the first leg portion of the third current path portion are formed by the same shaped conductor. If the corresponding last and first leg portions are formed by one shaped conductor in each case, the suitable design of said shaped conductor is advantageously sufficient to implement the interconnection of two current path portions.

Furthermore, in the stator according to the invention, provision may be made for the leg portion or the leg portions of the first current path portion of the at least one current path to occupy only that double layer which comprises the reference layer. It is thus possible for the position of the reversal of the winding direction to be varied through the arrangement of the leg portions in only one double layer.

Preferably, the leg portions of the second current path portion and/or of the third current path portion of the at least one current path occupy each double layer.

If the first current path portion comprises a plurality of leg portions, provision is made in particular for the plurality of leg portions, which are successive in terms of the series connection, of the first current path portion of the at least one current path to occupy immediately adjacent winding zones of the same strand along that circumferential direction which is opposite to the reference direction. This means that a second reversal of the winding direction is formed by the last leg portion of the first current path portion and the first leg portion of the second current path portion.

In the stator according to the invention, it is furthermore advantageous if the number of leg portions of the first current path portion is an odd number. This makes it possible in particular for the first outer leg portion to project out of the stator core on one of the end sides, and for the connecting portion that connects the last leg portion of the first current path portion to the first leg portion of the second current path portion to be arranged on the other end side. Provision may also be made for the number of leg portions of the third current path portion to be an odd number, such that the sum of the numbers of the leg portions of the first current path portion and of the third current path portion yields an even number.

The number of leg portions of the second current path portion is preferably an even number. The connecting portion that connects the last leg portion of the first current path portion to the first leg portion of the second current path portion, and the connecting portion that connects the last leg portion of the second current path portion to the first leg portion of the third current path portion, may then be arranged on the same end side.

In a particularly preferred embodiment of the stator according to the invention, provision is made for the outer leg portions of the at least one current path to be arranged in immediately adjacent winding zones of the same strand and/or in different layers of the same double layer. This makes it possible for the outer leg portions of the at least one current path to be contacted spatially closely to one another and/or at different radial positions.

For the current path of the first type, two embodiment alternatives are preferably provided:

In the first preferred embodiment alternative, provision is made for the first leg portion of the second current path portion to follow the last leg portion of the first current path portion along the second circumferential direction, and/or for the first leg portion of the third current path portion to follow the last leg portion of the second current path portion along the first circumferential direction.

In the second preferred embodiment alternative, provision is made for the first leg portion of the second current path portion to follow the last leg portion of the first current path portion along the first circumferential direction, and/or for the first leg portion of the third current path portion to follow the last leg portion of the second current path portion along the second circumferential direction.

Furthermore, in the stator according to the invention, provision may be made for one current path to be formed as a second current path of the first type, wherein the outer leg portions of the current paths of the first type are arranged in the same winding zones. It is thus possible for a strand having a plurality of current paths to be formed, in which the current paths are situated close to one another, allowing contacting of the current paths spatially closely to one another. The first outer leg portions of the first current path of the first type and of the second current path of the first type are particularly preferably situated in the same layer of the same winding zone. Furthermore, the second outer leg portion of the first current path of the first type and of the second current path of the first type may be situated in the same layer of the same winding zone.

Provision may be made in particular for one of the outer leg portions of the first current path of the first type to be connected in series with one of the outer leg portions of the second current path of the first type, or for the first current path of the first type and the second current path of the first type to be connected in parallel. In the case of parallel connection, it is preferable if the first outer leg portions of the first current path of the first type and of the second current path of the first type are connected to one another, and if the second outer leg portions of the first current path of the first type and of the second current path of the first type are connected to one another.

If two current paths are connected in series, they may be connected to one another by one of the connecting portions.

If only one current path of the first type is provided, this may occupy each layer in all winding zones of the same strand. If a plurality of current paths of the first type are provided, the leg portions of the current paths of the first type, in particular of the first current path of the first type and of the second current path of the first type, may occupy each layer in all winding zones of the same strand. Alternatively or in addition, provision may be made for the leg portions of the second current path portion of each one of the current paths of the first type to occupy all winding zones of the same strand in each double layer. Alternatively or in addition, provision may be made for the number of leg portions, arranged in that double layer which comprises the reference layer, of the first and third current path portions of each one of the current paths of the first type to correspond to the number of winding zones of one of the strands.

Provision may furthermore be made for one current path to be formed as a current path of a second type, in which the reference layer is the first layer and the reference direction is the first circumferential direction, and for the first leg portion of the second current path portion to follow the last leg portion of the first current path portion in the opposite circumferential direction in relation to the current path of the first type, and/or for the first leg portion of the third current path portion to follow the last leg portion of the second current path portion in the opposite circumferential direction in relation to the current path of the first type.

One current path may also be formed as a second current path of the second type. It is preferred here if the outer leg portions of the current paths of the second type are arranged in the same winding zones. In particular, the first outer leg portions of the current paths of the second type are arranged in the same layer, and the second outer leg portions of the current paths are arranged in the same layer. Provision is preferably made whereby, in one of the winding zones, in each case one of the outer leg portions of the current paths is of the first and of the second type, and the other outer leg portions of the current paths of the first type, on the one hand, and the other outer leg portions of the current paths of the second type, on the other hand, are arranged in different winding zones. In particular, provision is made for the second outer leg portions of the current paths of the first type and the first outer leg portions of the current paths of the first type to be arranged in the same specified winding zone, for the first leg portions of the current paths of the first type to be arranged in that winding zone which is immediately adjacent along the second circumferential direction, and for the second leg portions of the current paths of the second to be arranged in that winding zone which is immediately adjacent along the first circumferential direction.

In one embodiment variant, it is possible for each strand to have first and second current paths of the first type and first and second current paths of the second type. In this case, the current paths of the first and of the second are preferably connected in parallel. In this case, provision may be made in particular for the first outer leg portions of the current paths of the first type and the second outer leg portions of the current paths of the second type to be connected to one another, and for the second outer leg portions of the current paths of the first type and the first outer leg portions of the current paths of the second type to be connected to one another.

In an alternative embodiment variant, provision may be made for one subset of the strands to have first and second current paths of the first type, and for one subset of the strands to have first and second current paths of the second type. In this case, the current paths of each one of the strands are preferably connected in series.

Furthermore, in the stator according to the invention, provision may be made for one current path to be formed as a current path of a third type, in which the reference layer is the L-th, and the reference direction is the second circumferential direction. In the current path of the third type, provision may be made for the first leg portion of the second current path portion to follow the last leg portion of the first current path portion along the same circumferential direction as in the current path of the first type, and/or for the first leg portion of the third current path portion to follow the last leg portion of the second current path portion in the same circumferential direction as in the current path of the first type. Alternatively or in addition, provision may be made for the outer leg portions to be arranged in the same winding zones as in the current path of the first type.

Provision may furthermore be made for one current path to be formed as a second current path of the third type, wherein the outer leg portions of the current paths of the third type are arranged in the same winding zones.

Preferably, each strand has first and second current paths of the first type and first and second current paths of the third type. Provision may be made for the number of leg portions of the first current path portion of the current paths of the first type and of the current paths of the third type in one subset of the strands to differ from that number in another subset of the strands.

If two current paths of the first type and two current paths of the second or third type are provided, the following may be provided: The current paths of the first type and the current paths of the second or third type may occupy all winding zones of the same strand. Alternatively or in addition, the leg portions of the second current path portion of each one of the current paths of the first type and of each one of the current paths of the second or third type may occupy half of the winding zones in each double layer. Alternatively or in addition, the number of leg portions, arranged in that double layer which comprises the reference layer, of the first and third current path portions of each one of the current paths of the first type and of the current paths of the second or third type may correspond to half of the number of winding zones of one of the strands.

Each winding zone may extend over a number q of slots in each layer, where q≥2. The number q may in this case correspond to the number of holes in the stator winding. Furthermore, provision may be made for each winding zone to be subdivided in the circumferential direction into first q-th partial winding zones, which are named according to their order along one of the circumferential directions, in particular along the second circumferential direction. On the one hand, it is possible for each winding zone to extend over exactly q slots. The stator then has an even stator winding. It is alternatively also possible for each winding zone to extend over q+k slots, in particular over exactly q+1 slots, and for each partial winding zone to extend over k+1 slots, where k is a natural number. In this case, one subset of the double layers may be offset in the circumferential direction in relation to the other double layers. The first to j-th double layers may be offset in relation to the (j+1)-th to (L/2)-th double layers, where 1≤j≤(L/2)−1. In particular, the first to (L/4)-th double layers are offset in relation to the [(L/4)+1]-th to (L/2)-th double layers. The stator may then have a chorded stator winding.

The leg portions of each one of the current path portions are preferably arranged in the same partial winding zone. The leg portions of the corresponding current path portions of different current paths of the same type may be arranged in different partial winding zones.

The leg portions of the first current path portion and of the third current path portion, on the one hand, and the leg portions of the second current path portion, on the other hand, may be arranged in different partial winding zones. Alternatively, the leg portions of the first and second current path portions of each one of the first current paths may be arranged in the same partial winding zone, and the leg portions of the third current path portion of each one of the first current paths may be arranged in another partial winding zone. The outer leg portions of the at least one current path may be spaced apart from one another by N·q or N·q+1 or N·q−1 slots.

In a preferred embodiment of the stator according to the invention, provision may furthermore be made for each shaped conductor to integrally form two of the leg portions and one of the connecting portions provided on the first end side, and for the connecting portions provided on the second end side to be formed by electrically conductive and mechanical connection of two of the shaped conductors. Such shaped conductors may also be referred to as U-pins. The shaped conductors are connected on the second end side preferably cohesively, in particular by welding.

Provision may be made for each one of the outer leg portions of the at least one current path to be connected, by one of the connecting portions provided on the first end side, to that leg portion which directly follows said outer leg portion in terms of the series connection. This means in particular that the outer leg portions project out of the stator core on the second end side, and can be or are contacted there.

Preferably, the last leg portion of the first current path portion and the first leg portion of the second current path portion of the at least one current path are connected by one of the connecting portions provided on the first end side, and/or the last leg portion of the second current path portion and the first leg portion of the third current path portion of the at least one current path are connected by one of the connecting portions provided on the first end side.

The stator preferably also has a connection device which contacts at least a subset of the outer shaped conductors of the at least one current path of each one of the strands in order to feed in a multi-phase AC voltage at the second end side.

The connection device may form the parallel connection of the current paths. The connection device may furthermore have a star point connection that forms the star connection of the strands. Here, the outer leg portions that are connected to the star point connector are preferably arranged in the same layer.

Provision may also be made for a pair of first and last leg portions, arranged in the same winding zones and in the same layer, in particular in the radially outermost of the layers, of different current paths to be formed a shaped conductor arrangement composed of a first of the shaped conductors, the leg portions of which are spaced apart by a specified number of slots, and a second of the shaped conductors, the leg portions of which are spaced apart by a number of slots that is lower than the specified number. That connecting portion of the second shaped conductor which is provided on the first end side may be arranged axially between the stator core and that connecting portion of the first shaped conductor which is arranged on the first end side.

Provision may also be made for a pair of first and last leg portions, arranged in the same winding zones and in the same layer, in particular in the radially innermost of the layers, of different current paths to be formed a shaped conductor arrangement composed of a first of the shaped conductors, the leg portions of which are spaced apart by a specified number of slots, and a second of the shaped conductors, the leg portions of which are spaced apart by a number of slots that is lower than the specified number. The shaped conductors of the shaped conductor arrangement may have two oblique portions which each adjoin one of the leg portions and extend in the axial direction pointing away from the stator core and in the circumferential direction, wherein each one of the oblique portions is adjoined by an axial portion which extends further axially away from the stator core than the connecting portions formed by the other shaped conductors, wherein each one of the axial portions is adjoined by a radial portion which covers the other shaped conductors, and the radial portions are connected by a bridge portion which extends along the other shaped conductors in the circumferential direction, wherein the connecting portion of the first shaped conductor borders the connecting portion of the second shaped conductor.

Typically, the leg portions of the first shaped conductor are spaced apart from one another by N·q+1 slots, and the leg portions of the second shaped conductor are spaced apart from one another by N·q−1 slots. The shaped conductors of such shaped conductor arrangements may also be referred to as U-inside-U pins.

The invention also relates to an electric machine having an above-described stator and having a rotor mounted rotatably relative to the stator. The electric machine may be a synchronous machine. The rotor may be permanently excited or electrically excited. Alternatively, the electric machine may be an asynchronous machine. The electric machine is preferably designed to drive a vehicle.

The invention also relates to a vehicle having an electric machine according to the invention, which is designed to drive the vehicle. The vehicle may be a battery electric vehicle (BEV) or a hybrid vehicle.

Further advantages and details of the present invention will become apparent from the exemplary embodiments described below and with reference to the drawings. The drawings are schematic illustrations in which:

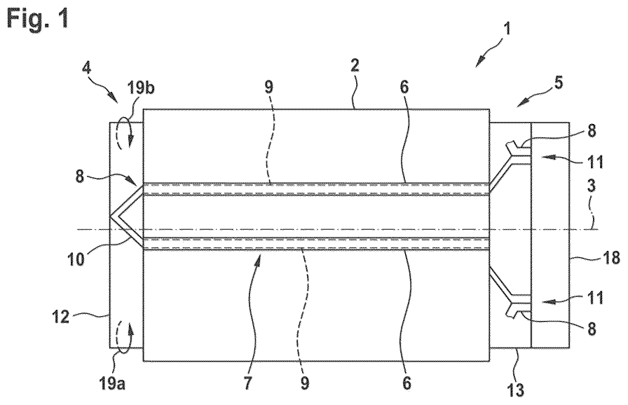

FIG. 1 shows a schematic diagram of a first exemplary embodiment of a stator according to the invention;

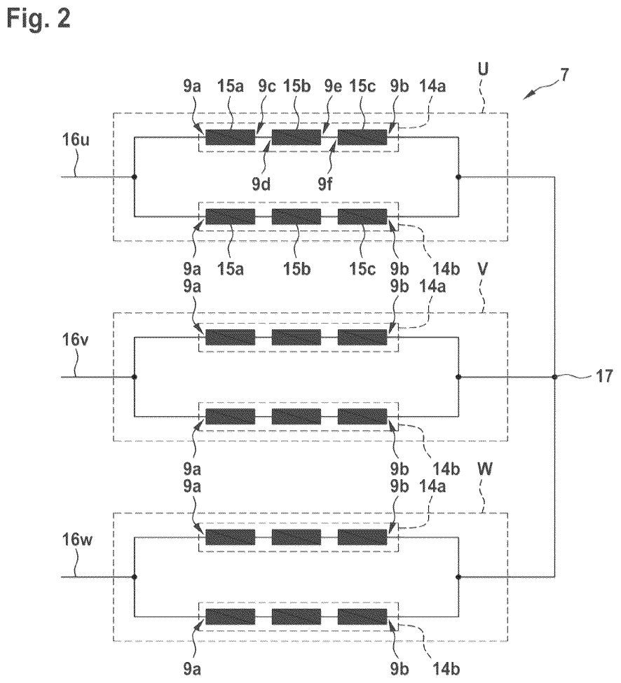

FIG. 2 shows a block circuit diagram of the stator winding of the stator according to the first exemplary embodiment;

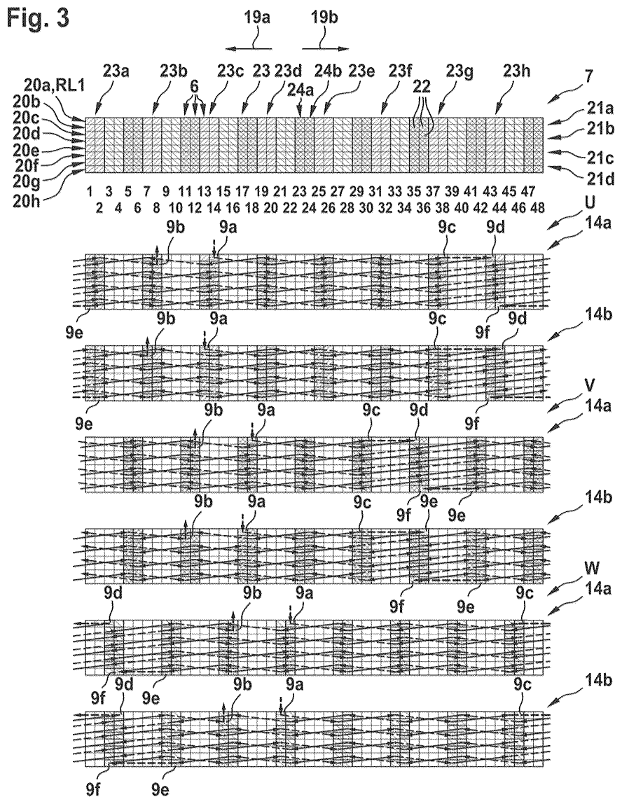

FIG. 3 shows a winding pattern of the stator winding of the stator according to the first exemplary embodiment;

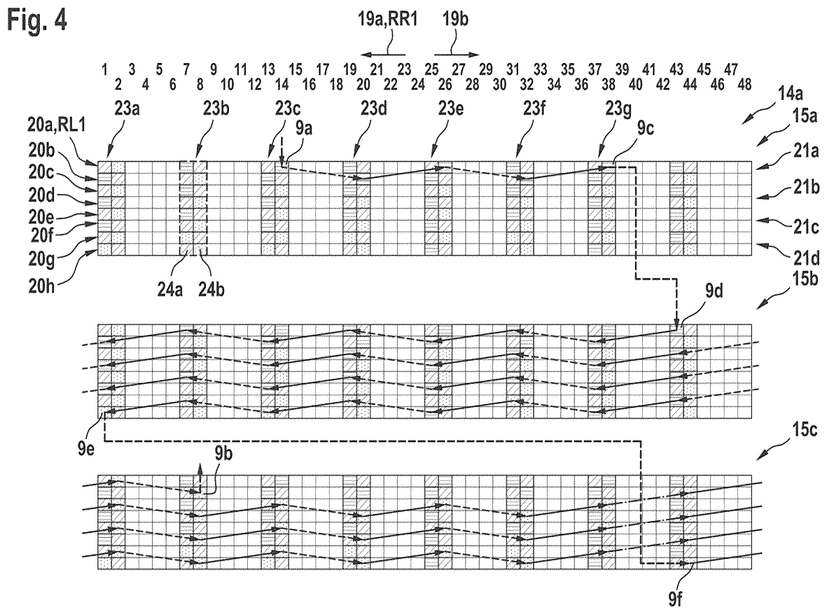

FIG. 4 shows a winding pattern of the current path portions of the first current path of the first type according to the first exemplary embodiment;

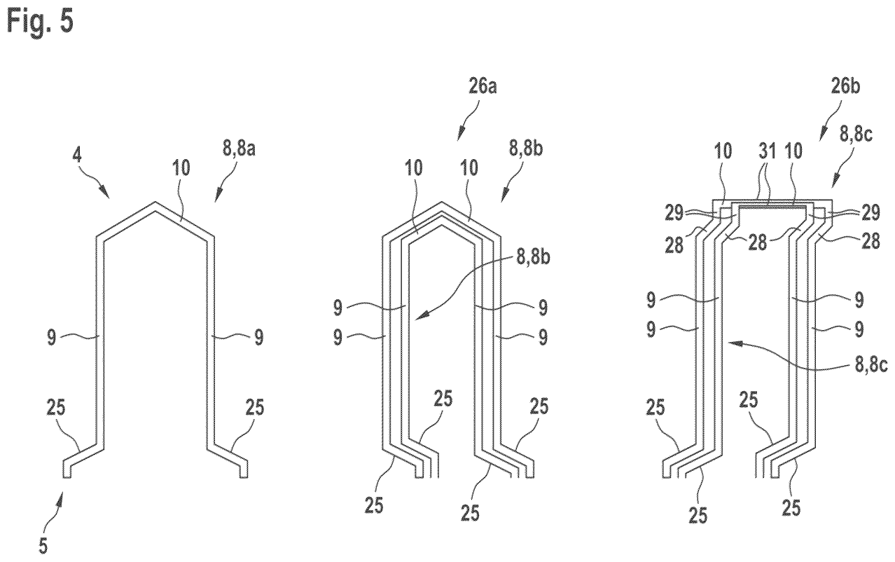

FIG. 5 shows a schematic diagram of shaped conductors of the first, second and third types according to the first exemplary embodiment;

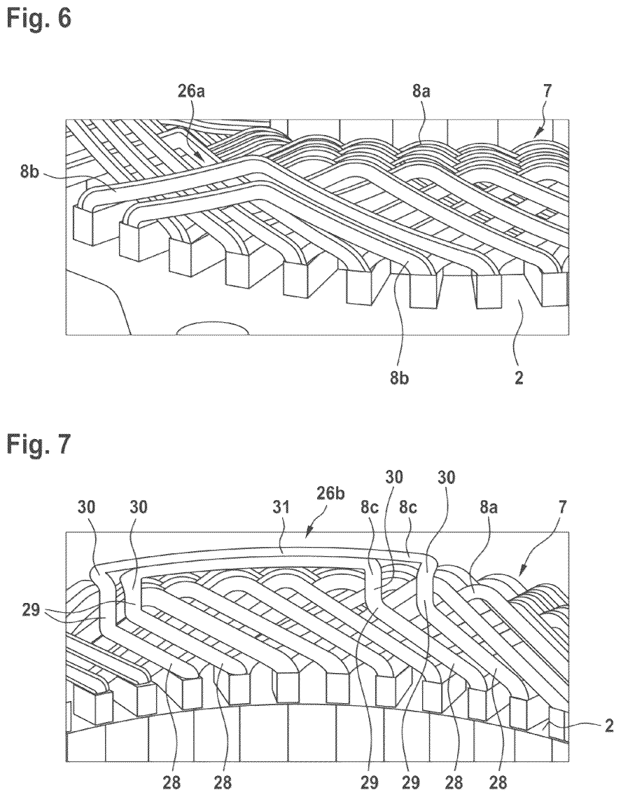

FIG. 6 shows a perspective view of the winding head with shaped conductors of the second type according to the first exemplary embodiment;

FIG. 7 shows a perspective view of the winding head with shaped conductors of the third type according to the first exemplary embodiment;

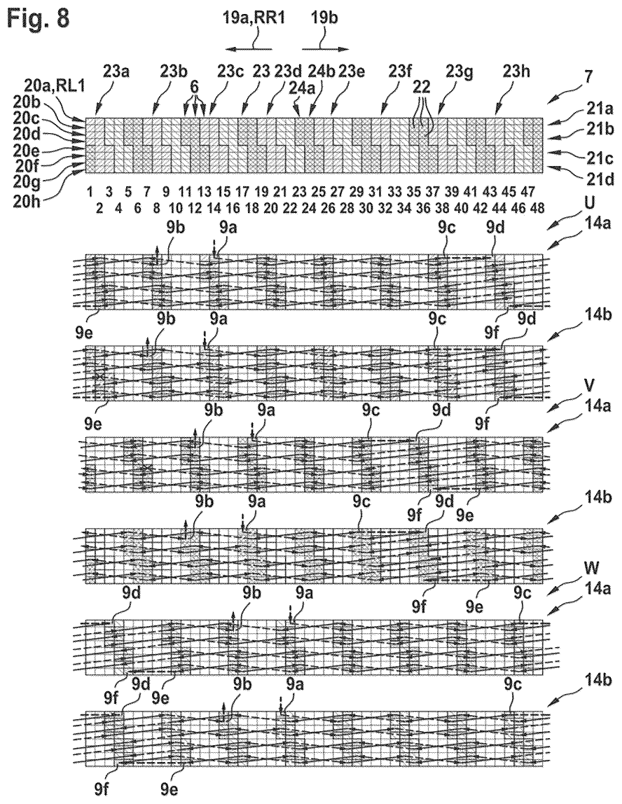

FIG. 8 shows a winding pattern of the stator winding according to a second exemplary embodiment of the stator according to the invention;

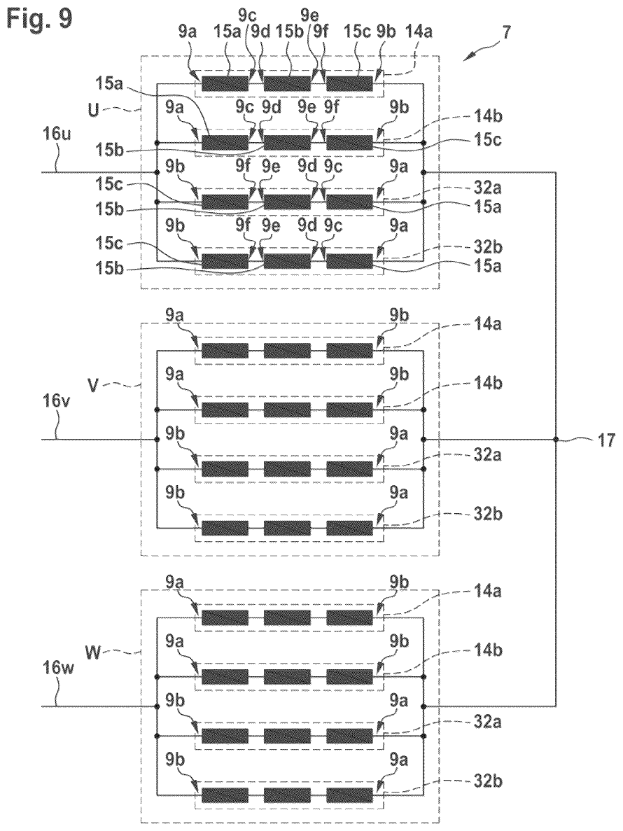

FIG. 9 shows a block circuit diagram of the stator winding of a third exemplary embodiment of the stator according to the invention;

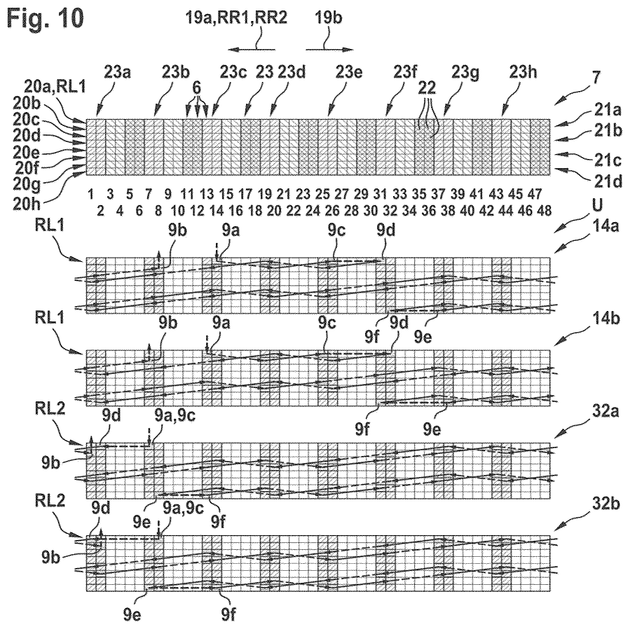

FIG. 10 shows a winding pattern of one of the strands of the stator winding according to the third exemplary embodiment;

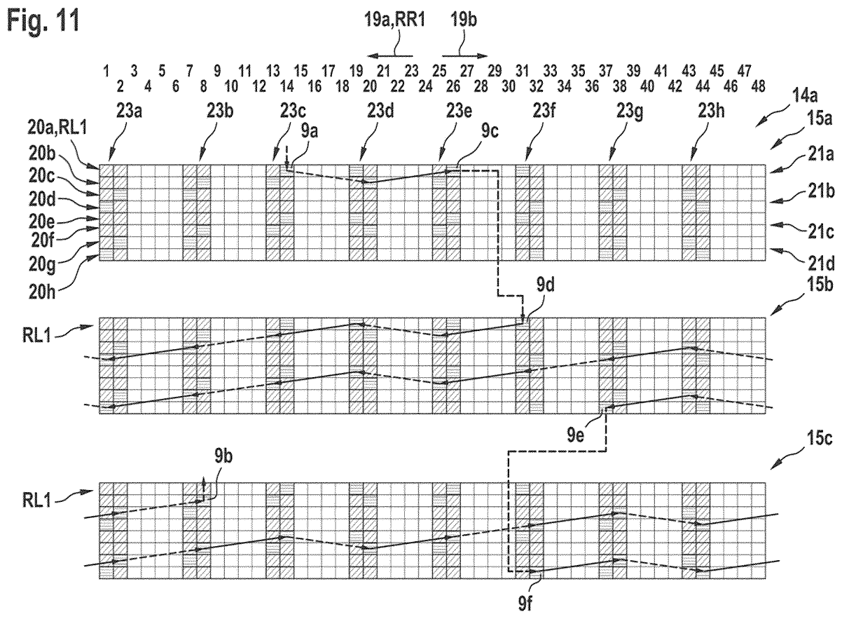

FIG. 11 shows a winding pattern of the current path portions of the first current path of the first type according to the third exemplary embodiment;

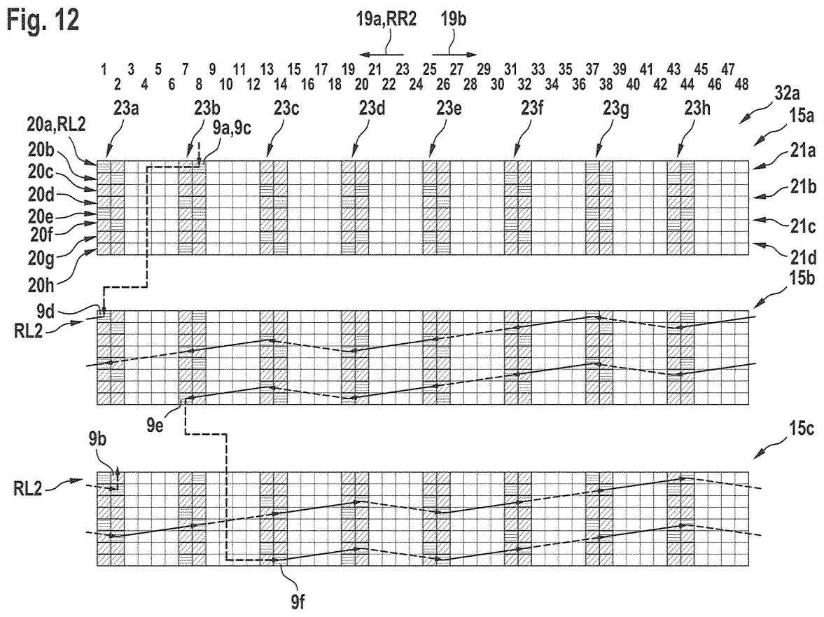

FIG. 12 shows a winding pattern of the current path portions of the first current path of the second type according to the third exemplary embodiment;

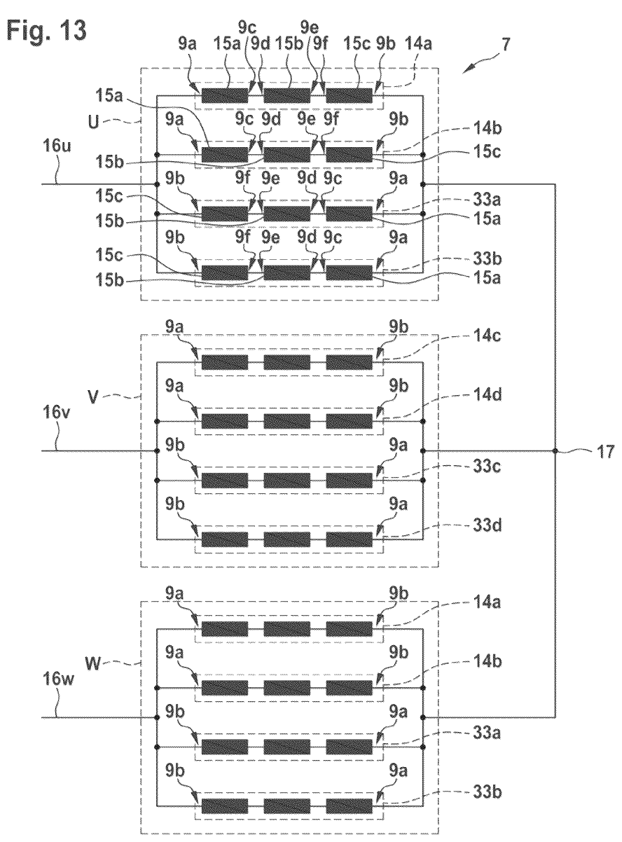

FIG. 13 shows a block circuit diagram of the stator winding of a fourth exemplary embodiment of the stator according to the invention;

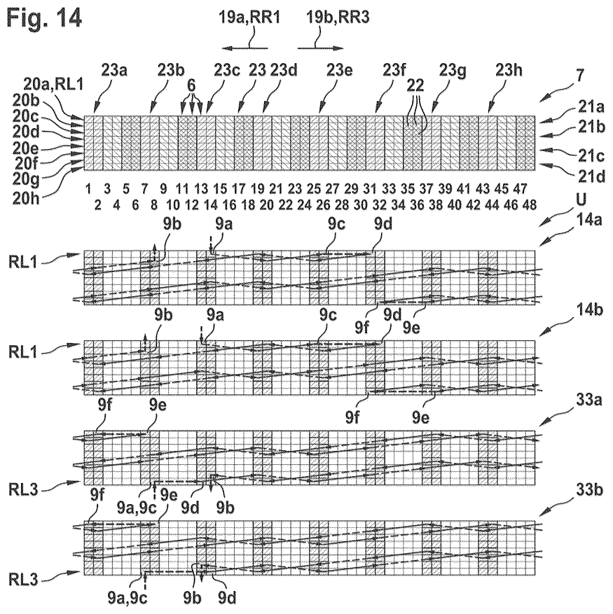

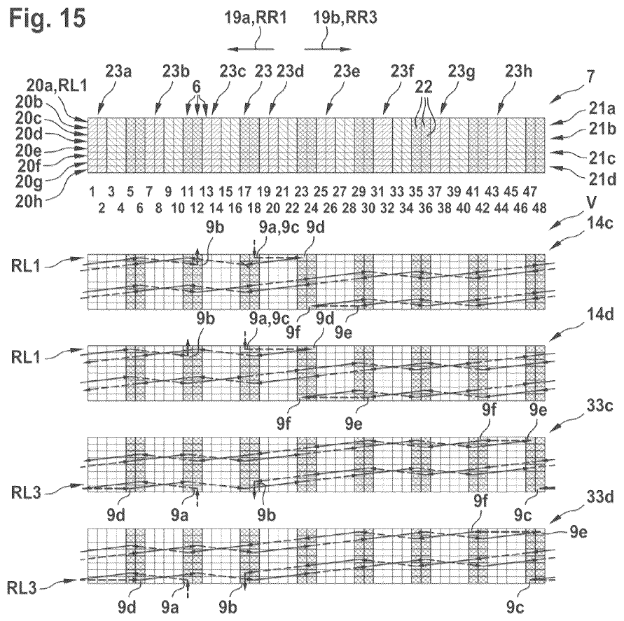

FIGS. 14 and 15 each show a winding pattern of one of the strands of the stator winding according to the fourth exemplary embodiment;

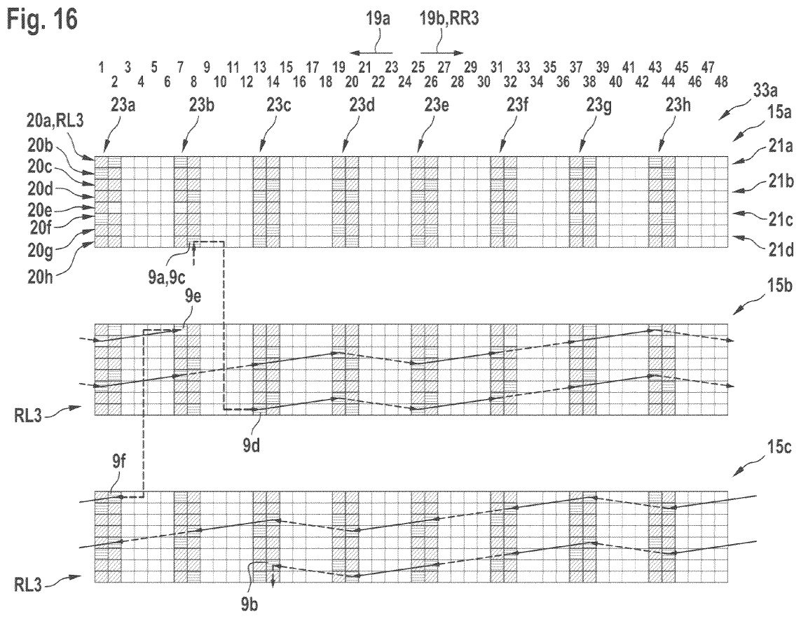

FIG. 16 shows a winding pattern of the current path portions of the first current path of the third type of one of the strands according to the fourth exemplary embodiment;

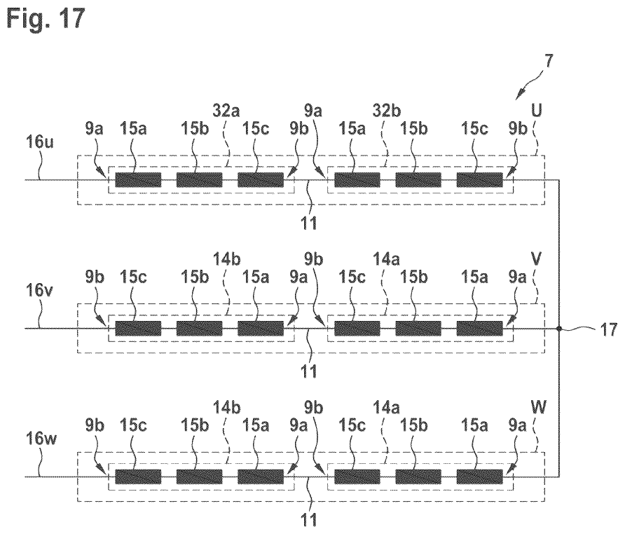

FIG. 17 shows a block circuit diagram of the stator winding of a fifth exemplary embodiment of the stator according to the invention;

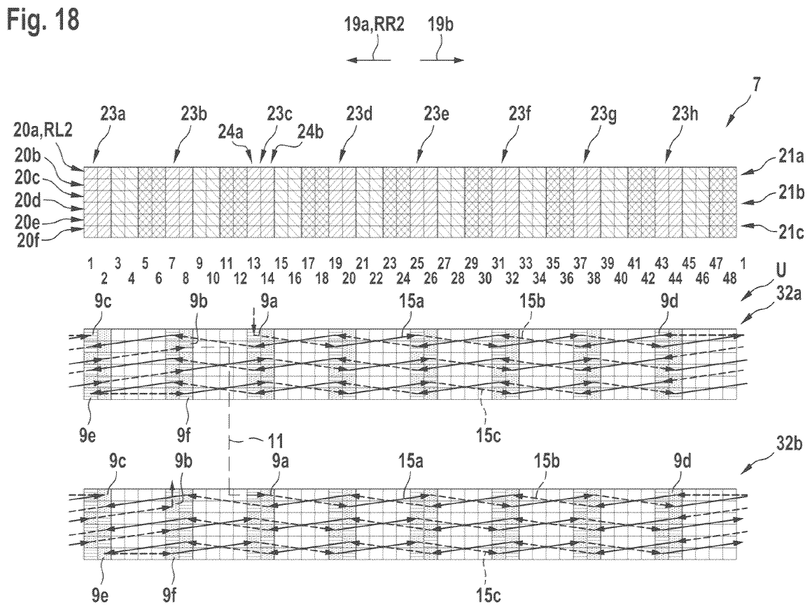

FIGS. 18 to 20 each show a winding pattern of one of the strands of the stator winding according to the fifth exemplary embodiment; and

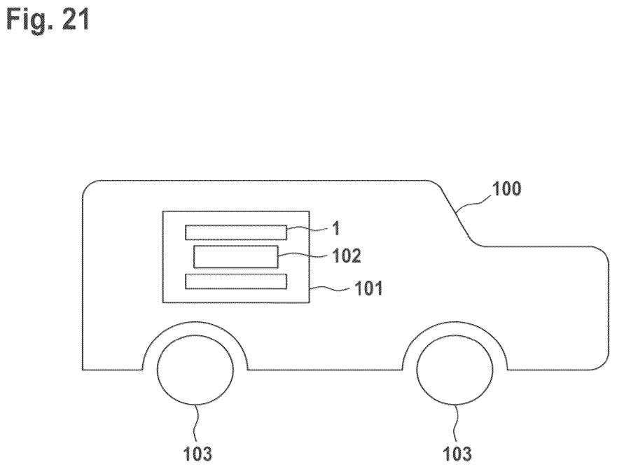

FIG. 21 shows a schematic diagram of a vehicle having an exemplary embodiment of an electric machine according to the invention.

FIG. 1 shows a schematic diagram of a first exemplary embodiment of a stator 1.

The stator 1 has a stator core 2 which has a longitudinal axis 3, a first end side 4 and a second end side 5 situated opposite the end side 4. Extending from the first end side 4 to the second end side 5 is a plurality of slots 6, arranged in the circumferential direction, of the stator core 2, with only two of said slots being schematically illustrated in FIG. 1. By way of example, the stator core 2 is formed from a plurality of axially layered individual laminations (not shown) that are electrically insulated from one another, such that said stator core can also be referred to or regarded as a stator laminated core.

The stator 1 also has a stator winding 7, which in the present exemplary embodiment has N=3 strands U, V, W (see FIG. 2). Each strand U, V, W is formed by shaped conductors 8, which have leg portions 9 arranged within the slots 6. The shaped conductors 8 also have connecting portions 10, 11 which electrically conductively connect in each case two of the leg portions 9 to one another. The connecting portions 10 are provided on the first end side 4 and form a winding head 12 there. The connecting portions 11 are provided on the second end side 5 and form a further winding head 13 there. FIG. 1 schematically illustrates only one shaped conductor 8 in its entirety, and illustrates two other shaped conductors 8 which together with the aforementioned shaped conductor form in each case one of the connecting portions 11 on the second end side 5.

FIG. 2 shows a block circuit diagram of the stator winding 7 of the stator 1 according to the first exemplary embodiment.

Each strand U, V, W has a first current path of a first type 14a and a second current path of the first type 14b. Each current path of the first type 14a, 14b is formed from a plurality of leg portions 9 and a plurality of connecting portions 10, 11 which connect the leg portions 9 to form a series connection. In relation to the series connection, the first current path of the first type 14a and the second current path of the first type 14b each have a first outer leg portion 9a and a second outer leg portion 9b situated opposite the first outer leg portion 9a. That is to say, in each case, a first and a last of the leg portions 9 that form the 17 series connection of the current path of the first type 14a, 14b are the outer leg portions 9a, 9b.

The first current path 14a and the second current path 14b each have a first current path portion 15a, a second current path portion 15b and a third current path portion 15c, which each comprise a plurality of the leg portions 9 that are successive in terms of the series connection. In each current path of the first type 14a, 14b, one of the leg portions 9 is a last leg portion 9c of the first current path portion 15a, one of the leg portions 9 is a first leg portion 9d of the second current path portion 15b, one of the leg portions 9 is a last leg portion 9e of the second current path portion 15b, and one of the leg portions 9 is a first leg portion 9f of the third current path portion 15c. The last leg portion 9c of the first current path portion 15a is connected by means of one of the connecting portions 10 directly to the first leg portion 9d of the second current path portion 15b. The last leg portion 9e of the second current path portion 15b is connected by means of one of the connecting portions 10 directly to the first leg portion 9f of the third current path portion 15c.

In the present exemplary embodiment, by way of example, provision is made for the current paths of the first type 14a, 14b of each one of the strands U, V, W to be connected in parallel, specifically such that, in each strand U, V, W, the first outer leg portions 9a of the first current path of the first type 14a and of the second current path of the first type 14b are connected to one another, and the second outer leg portions 9b of the first current path of the first type 14a and of the second current path of the first type 14b are connected to one another.

In the present exemplary embodiment, the strands U, V, W are, by way of example, inter-connected as a star connection. For this purpose, the stator 1 has a phase connection 16u, 16v, 16w for each of the strands U, V, W. The strands U, V, W are interconnected, at their ends situated opposite the phase connections 16u, 16v, 16w, to form a star point 17. For this purpose, the phase connections 16u, 16v, 16w are each connected to the first outer leg portion 9a of an associated current path of the first type 14a, 14b of one of the strands U, V, W. The second outer leg portions 9b of the first current path 14a of each of the strands U, V, W are interconnected to form the star point 17. The phase connections 16u, 16v, 16w and the star point 17 are formed here by a connection device 18, schematically illustrated in FIG. 1, on the second end side 5.

FIG. 3 shows a winding pattern of the stator winding 7 according to the first exemplary embodiment.

In each table in FIG. 3, a column corresponds to one of the slots 6, which are denoted using slot numbering. By way of example, in the present exemplary embodiment, the stator core 2 has 48 slots. Also indicated are a first circumferential direction 19a and a second circumferential direction 19b that is opposite to the first circumferential direction. As is apparent from FIG. 1, the first circumferential direction 19a in this case corresponds, for example when viewing the first end side 4, to counterclockwise, and the second circumferential direction 19b corresponds to clockwise. The slots are numbered along the second circumferential direction 19b.

Each slot 6 is subdivided radially into L =8 layers 20a to 20h, namely a first layer 20a, a second layer 20b, a third layer 20c, a fourth layer 20d, a fifth layer 20e, a sixth layer 20f, a seventh layer 20g and an eighth layer 20h. The layers 20a to 20h correspond to the rows of the tables in FIG. 3. The slots 6 are named according to their order in the radial direction, wherein, here, by way of example, the first layer 20a is the radially outermost and the eighth layer 20h is the radially innermost. Each slot 6 is furthermore subdivided into L/2=4 double layers 21a to 21d, wherein the first double layer 21a comprises the first layer 20a and the second layer 20b, the second double layer 21b comprises the third layer 20c and the fourth layer 20d, the third double layer 21c comprises the fifth layer 20e and the sixth layer 20f, and the fourth double layer 21d comprises the seventh layer 20g and the eighth layer 20h.

Each layer 20a to 20h in each one of the slots 6 forms a receiving space 22 for one of the leg portions 9, such that the number of slots multiplied by the number of layers corresponds to the number of receiving spaces 20. In the present exemplary embodiment, 384 receiving spaces 22 are formed. Each receiving space corresponds to one cell of the tables in FIG. 3.

For each one of the strands U, V, W, the receiving spaces 22 form eight winding zones 23a to 23h, wherein, in the upper table, the winding zones belonging to the same strand U, V, W are provided with the same hatching, and the winding zones of the strand U are denoted by reference signs. Each winding zone 23a to 23h has a number of q=2 receiving spaces 22 in each layer. In the present exemplary embodiment, each winding zone extends over precisely q=2 slots 6. The value q therefore corresponds to the number of holes in the stator winding 7.

The lower tables show the arrangement of the leg portions 9, 9a to 9f in the receiving spaces 22 and the connection thereof by means of the connecting portions 10, 11, wherein the connecting portions 10 on the first end side 4 are indicated by dashed arrows and the connecting portions 11 on the second end side 5 are denoted by solid arrows. It should be noted here that the arrow direction does not necessarily correspond to a direction of current through the leg portions 9, 9a to 9f or through the connecting portions 10, 11.

The winding pattern will be discussed in more detail below on the basis of the strand U. The leg portions of the other strands V, W are arranged identically, aside from an offset by q=2 slots along the first circumferential direction 19a in the case of strand V and along the second circumferential direction 19b in the case of strand W. The statements made regarding the strand U are thus transferable to the other strands V, W.

FIG. 4 shows a winding pattern of the first current path of the first type 14a of the strand U according to the first exemplary embodiment, wherein FIG. 4 shows the current path portions 15a to 15c of the first current path of the first type 14a in separate tables. The statements made regarding the first current path of the first type 14a are thus transferable to the second current path of the first type 14b.

The last leg portion 9c of the first current path portion 15a and the first leg portion 9d of the second current path portion 15b are arranged in a reference layer RL1, which in the current paths of the first type 14a, 14b is the first layer 20a. The last leg portion 9e of the second current path portion 15b and the first leg portion 9f of the third current path portion 15c are arranged in that layer which is situated radially opposite the reference layer RL1, in this case in the eighth layer 20h (the L-th layer). The outer leg portions 9a, 9b are arranged in that double layer which comprises the reference layer RL1, that is to say in the present case in the first double layer 21a.

The leg portions 9, 9d, 9e of the second current path portion 15b occupy immediately adjacent winding zones 23a to 23h of the same strand U from the first leg portion 9b to the last leg portion 9e of the second current path portion 15b along one of the circumferential directions 19a, 19b as reference direction RR1. In the current paths of the first type 14a, 14b, the reference direction RR1 is the first circumferential direction 19a. The leg portions of the third current path portion 15c occupy immediately adjacent winding zones 23a to 23h of the same strand U from the first leg portion 9f of the third current path portion 15c to the second outer leg portion 9b along that one of the circumferential directions 19a, 19b which is opposite to the reference direction RR1, that is to say along the second circumferential direction 19b. In the present exemplary embodiment, the first current path portion 15a comprises a plurality of leg portions 19b. These occupy immediately adjacent winding zones 23a to 23h of the same strand U from the first outer leg portion 9a to the last leg portion 9c of the first current path portion 15a along that one of the circumferential directions which is opposite to the reference direction RR1, that is to say along the second circumferential direction 19b.

FIG. 4 also shows that, from each occupied winding zone 23a to 23h to the next winding zone 23a to 23h, the leg portions 9, 9a to 9f of each current path portion 15a to 15c alternate between layers 20a to 20h of the double layer 21a to 21d. Each current path portion 15a to 15c accordingly forms a wave winding.

The leg portions 9, 9a, 9c of the first current path portion 15a occupy only that double layer 21a which comprises the reference layer 20a. Here, said leg portions occupy only a specified number of winding zones 23a to 23h, in this case for example five winding zones 23b to 23h. The specified number is an odd number.

By contrast, the leg portions 9, 9d, 9e of the second current path portion 15b occupy all winding zones 23a to 23h of the same strand U. Here, the leg portions 9, 9d, 9e of the second current path portion 15b occupy each winding zone 23a to 23h once in each double layer 21a to 21d. In other words, the second current path portion 15b completes a number of full circuits about the stator core 2 along the reference direction RR1, said number corresponding to the number of double layers 21a to 21d.

The leg portions 9, 9b, 9f of the third current path portion 15c also occupy each double layer 21a to 21d. Here, the leg portions 9, 9b, 9f of the third current path portion 15c occupy each winding zone 23a to 23h of each double layer 21a to 21d once, aside from that double layer 21a which comprises the reference layer RR1. In other words, the third current path portion 15c completes a number of full circuits along that circumferential direction 19b which is opposite to the reference direction RR1, said number corresponding to the number of double layers 21a to 23h, reduced by one. In that double layer 21a which comprises the reference layer RR1, the leg portions 9, 9b, 9f of the third current path portion 15c occupy a number of winding zones that corresponds to the number of winding zones 23a to 23h of the strand U minus the number of winding zones 23a to 23f occupied by the leg portions 9, 9a, 9c of the first current path portion 15a.

Furthermore, in the current paths of the first type 14a, 14b, the first leg portion 9d of the second current path portion 15b follows the last leg portion 9c of the first current path portion 15a along the second circumferential direction 19b. The first leg portion 9f of the third path portion 15c follows the last leg portion 9e of the second current path portion 15b along the first circumferential direction 19a.

It can also be seen in FIG. 4 that the outer leg portions 9a, 9b are arranged in immediately adjacent winding zones 23b, 23c of the same strand U. The outer leg portions 9a, 9b are furthermore arranged in different layers 20a, 20b of the same double layer 21a.

FIG. 4 also shows that each winding zone 23a to 23g is subdivided in the circumferential direction into first to second (q-th) partial winding zones which are named according to their order along the second circumferential direction 19b, wherein each partial winding zone comprises a receiving space 22 in each of the layers 20a to 20h. In the present exemplary embodiment, each partial winding zone 20a to 20h extends over exactly one slot 6.

In the first exemplary embodiment, the leg portions 9, 9a to 9f of each one of the current path portions 15a, 15b, 15c are arranged in the same partial winding zone. Here, the leg portions 9, 9a, 9b, 9c, 9f of the first current path portion 15a and of the third current path portion 15c, on the one hand, and the leg portions 9, 9d, 9e of the second current path portion 15b, on the other hand, are arranged in different partial winding zones 24a, 24b. By way of example, the leg portions 9, 9d, 9e of the second current path portion 15b are arranged in the first partial winding zone 24a.

Referring again to FIG. 3, it can be seen that the leg portions 9, 9a to 9f of each one of the current path portions 15a to 15c are arranged in different partial winding zones 24a, 22 24b in the first current path of the first type 14a and in the second current path of the second type 14b.

In the first current path of the first type 14a, the last leg portion 9c of the first current path portion 15a and the first leg portion 9d of the second current path portion 15b, and also the last leg portion 9e of the second current path portion 15b and the first leg portion 9f of the third current path portion 15c, are spaced apart from one another by N·q−1=5 slots in each case. In the second current path of the first type 14b, the last leg portion 9c of the first current path portion 15a and the first leg portion 9d of the second current path portion 15b, and also the last leg portion 9e of the second current path portion 15b and the first leg portion 9f of the third current path portion 15c, are spaced apart from one another by N·q+1=7 slots in each case. In the first current path of the first type 14a and in the second current path of the first type 14b, the outer leg portions 9a, 9b are spaced apart from one another by N·q=6 slots in each case. All other pairs of leg portions 9 that are directly successive in terms of the series connection are spaced apart from one another by N·q=6 slots in each case.

It is also apparent that the last leg portions 9c of the first current path portions 15a, the first leg portions 9d of the second current path portions 15b, the last leg portions 9e of the second current path portions 15b and the first leg portions 9f of the third current path portions 15c are arranged in the same winding zone 23a, 23g, 23h in each case.

FIG. 5 shows schematic diagrams of shaped conductors of a first type 8a, of a second type 8b and of a third type 8c. FIG. 6 shows a perspective view of the winding head 12 with shaped conductors of the second type 8b. FIG. 7 shows a perspective view of the winding head 12 with shaped conductors of the third type 8c.

The connecting portions 11 (see FIG. 1) formed on the second end side 5 are formed by electrically conductively and mechanically interconnected end portions 25 of two shaped conductors 8. Each shaped conductor 8 has two end portions 25 adjoining one of its leg portions 9.

The shaped conductors 8 comprise shaped conductors of the first type 8a. The end portions 25 of the shaped conductors of the first type 8a point away from one another in the first circumferential direction 19a and in the second circumferential direction 19b. The 23 shaped conductors 8 furthermore comprise shaped conductors of the second type 8b and shaped conductors of the third type 8c. The end portions 25 of each shaped conductor of the second and third type 8b, 8c point in the same circumferential direction 19a, 19b.

The shaped conductors of the second type 8b form the first leg portions 9d, 9f and last leg portions 9c, 9e, arranged in the radially outer layer, of two current path portions 15a, 15b , 15c. In the present exemplary embodiment, these are the last leg portion 9c of the first current path portion 15a and the first leg portion 9d of the second current path portion 15b of each one of the current paths of the first type 14a, 14b.

The two shaped conductors of the second type 8b that are arranged in the same winding zones 23g, 23h form a shaped conductor arrangement 26a. Here, the connecting portion 10 of a first shaped conductor of the second type 8b of the shaped conductor arrangement 26a connects two leg portions 9c, 9d that are spaced apart by N·q+1 slots 6, and the connecting portion 10 of a second shaped conductor of the second type 8b of the shaped conductor arrangement 26a connects two leg portions 9c, 9d that are spaced apart by N·q−1 slots 6. The connecting portion 10 of the second shaped conductor of the second type 8b is axially shorter than the connecting portion 10 of the first shaped conductor of the second type 8b and is arranged between the stator core 2 and the first shaped conductor of the second type 8b.

The shaped conductors of the third type 8c form the first leg portions 9d, 9f and last leg portions 9c, 9e, arranged in the radially inner layer, of two current path portions 15a, 15b, 15c. In the present exemplary embodiment, these are the last leg portion 9e of the second current path portion 15b and the first leg portion 9f of the third current path portion 15c of each one of the current paths of the first type 14a, 14b.

The connecting portion 10 of each one of the shaped conductors of the third type 8c has two oblique portions 28 which adjoin one of the leg portions 9 and extend in the axial direction pointing away from the stator core 2 and in the circumferential direction. Each one of the oblique portions 28 is adjoined by an axial portion 29 which extends further axially away from the stator core than the shaped conductors of the first type 8a. Each one of the axial portions 29 is adjoined by a radial portion 30 which covers the shaped conductors of the first type 8a. The radial portions 30 are connected by a bridge portion 31 that extends along the shaped conductors of the first type 8a in the circumferential direction.

The two shaped conductors of the third type 8c that are arranged in the same winding zones 23a, 23f form a shaped conductor arrangement 26b. Here, the connecting portion 10 of a first shaped conductor of the third type 8c of the shaped conductor arrangement 26b connects two leg portions 9 that are spaced apart by N·q+1 slots 6, and the connecting portion 10 of a second shaped conductor of the third type 8c of the shaped conductor arrangement 26b connects two leg portions 9 that are spaced apart by N q−1 slots 6. The connecting portion 10 of the first shaped conductor of the third type 8c borders the connecting portion 10 of the second shaped conductor of the third type 8c.

The other shaped conductors 8, that is to say in the present exemplary embodiment shaped conductors 8 having two leg portions 9 that are spaced apart by N·q slots 6, are formed by shaped conductors of the first type 8a.

Further exemplary embodiments of a stator 1 will be described below, with identical or functionally identical components being denoted by the same reference signs:

FIG. 8 shows a winding pattern of the stator winding 7 of a stator 1 according to a second exemplary embodiment. The second exemplary embodiment corresponds to the first exemplary embodiment, aside from the differences described below.

The stator winding 7 of the stator 1 according to the second exemplary embodiment is designed as a chorded stator winding. For this purpose, each winding zone 23a to 23h extends over q+1=3 slots, and each partial winding zone 24a, 24b extends over two slots 6. In each winding zone 23a to 23h, a subset of the double layers, in this case the third and the fourth double layer 21c, 21d, are offset by one slot along the second circumferential direction 19b in relation to a subset of the double layers that comprises the first double layer 21a, in this case the first double layer 21 and the second double layer 21b.

In the second exemplary embodiment, directly interconnected leg portions 9 that are arranged in offset double layers 21b, 21c are spaced apart from one another by N·q−1=5 slots rather than N·q=6 slots. These leg portions 9 are also formed by shaped conductors of the first type 8a.

FIG. 9 shows a block circuit diagram of the stator winding 7 of a stator 1 according to a third exemplary embodiment. The third exemplary embodiment corresponds to the first exemplary embodiment, aside from the differences described below.

In the third exemplary embodiment, each strand U, V, W has not only a first current path of the first type 14a and a second current path of the first type 14b but also a first current path of a second type 32a and a second current path of the second type 32b. In the third exemplary embodiment, by way of example, provision is made for the current paths of the first type 14a, 14b and the current paths of the second type 32a, 32b of each one of the strands U, V, W to be connected in parallel, specifically such that, in each strand U, V, W, the first outer leg portions 9a of the first current path of the first type 14a and of the second current path of the first type 14b, and also the second outer leg portions 9b of the first current path of the second type 32a and of the second current path of the second type 32b, are connected to one another and to the corresponding phase connection 16u, 16v, 16w. The second outer leg portions 9b of the first current path of the first type 14a and of the second current path of the first type 14b and the first outer leg portions 9a of the first current path of the second type 32a and of the second current path of the second type 32b are connected to one another and to the star point 17.

FIG. 10 shows a winding pattern of the strand U of the stator winding 7 according to the third exemplary embodiment.

The winding pattern will be discussed in more detail below on the basis of the strand U. The leg portions of the strand V are arranged identically aside from an offset by 2·N·q+4 slots 6 along the second circumferential direction 19b. The leg portions of the strand W are arranged identically aside from an offset by N·q+2 slots 6 along the second circumferential direction 19b. This means that the first outer leg portion 9a of the first current path of the first type 14a is arranged in slot number 30 in strand V and in slot number 22 in strand W, and the second outer leg portion 9b of the first current path of the first type 14a is arranged in slot number 24 in strand V and in slot number 16 in strand W. The first outer leg portion 9a of the second current path of the first type 14b is arranged in slot number 29 in strand V and in slot number 21 in strand W, and the second outer leg portion 9b of the second current path of the first type 14b is arranged in slot number 23 in strand V and in slot number 15 in strand W. The first outer leg portion 9a of the first current path of the second type 32a is arranged in slot number 23 in strand V and in slot number 15 in strand W, and the second outer leg portion 9b of the first current path of the second type 32a is arranged in slot number 17 in strand V and in slot number 9 in strand W. The first outer leg portion 9a of the second current path of the second type 32b is arranged in slot number 24 in strand V and in slot number 16 in strand W, and the second outer leg portion 9b of the second current path of the second type 32b is arranged in slot number 18 in strand V and in slot number 10 in strand W.

FIG. 11 shows a winding pattern of the first current path of the first type 14a of the strand U according to the third exemplary embodiment, wherein FIG. 11 shows the current path portions 15a to 15c of the first current path of the first type 14a in separate tables. The statements made regarding the first current path of the first type 14a are transferable to the second current path of the first type 14b.

The leg portions 9, 9a, 9c of the first current path portion 15a according to the third exemplary embodiment occupy only three winding zones 23c, 23d, 23e.

The leg portions 9, 9d, 9e of the second current path portion 15b occupy only half of the number of winding zones 23a to 23h in each double layer 21a to 21d. In the first double layer 21a and in the third double layer 21c, said leg portions occupy the winding zones 23c to 23f in each case, and in the second double layer 21b and in the fourth double layer 21d, said leg portions occupy the winding zones 23a, 23b, 23g, 23h in each case. The second current path portion 15b completes a number of full circuits about the stator core 2 along the reference direction RR1, said number corresponding to half of the number of double layers 21a to 21d.

The leg portions 9, 9b, 9f of the third current path portion 15c occupy only half of the number of winding zones 23a to 23h in each double layer 21b to 21h aside from that double layer 21a which comprises the reference layer RL1. In other words, the third current path portion 15c completes a number of full circuits along that circumferential direction 19b which is opposite to the reference direction RR1, said number corresponding to half of the number of double layers 21a to 23h, reduced by one. In that double layer 21a which comprises the reference layer RL1, the leg portions 9, 9b, 9f of the third current path portion 15c occupy a number of winding zones 23a that corresponds to half of the number of winding zones 23a to 23h of the strand U minus the number of winding zones 23c to 23e occupied by the leg portions 9, 9a, 9c of the first current path portion 15a.

FIG. 12 shows a winding pattern of the first current path of the second type 32a of the strand U according to the third exemplary embodiment, wherein FIG. 12 shows the current path portions 15a to 15c of the first current path of the second type 32a in separate tables. The statements made regarding the first current path of the second type 32a are transferable to the second current path of the second type 32b.

In the current paths of the second type 32a, 32b, the last leg portion 9c of the first current path portion 15a and the first leg portion 9d of the second current path portion 15b are arranged in a reference layer RL2 which is the first layer 20a. The last leg portion 9e of the second current path portion 15b and the first leg portion 9f of the third current path portion 15c are arranged in that layer which is situated radially opposite the reference layer RL2, specifically in the eighth layer 20h (the L-th layer). The outer leg portions 9a, 9b are arranged in that double layer which comprises the reference layer RL2, that is to say in the present case in the first double layer 21a.

The leg portions 9, 9d, 9e of the second current path portion 15b occupy immediately adjacent winding zones 23a to 23h of the same strand U from the first leg portion 9d to the last leg portion 9e of the second current path portion 15b along the first circumferential direction 19a as reference direction RR2. The leg portions of the third current path portion 15c occupy immediately adjacent winding zones 23a to 23h of the same strand U from the first leg portion 9e to the last leg portion 9f of the third current path portion 15c along the second circumferential direction 19b, which is opposite to the reference direction RR2.

In the present exemplary embodiment, the first current path portion 15a comprises only one leg portion 9a, 9c, which is arranged in the first double layer 21a. This means that, in the current paths of the second type 32a, 32b, the first outer leg portion 9a and the last leg portion 9c of the first current path portion 15a are identical. The number of winding zones 23a to 23g occupied by the first current path portion is thus one in the present case.

The leg portions 9, 9d, 9e of the second current path portion 15b occupy only half of the number of winding zones 23a to 23h in each double layer 21a to 21d. In the first double layer 21a and in the third double layer 21c, said leg portions occupy the winding zones 23a, 23f, 23g, 23h in each case, and in the second double layer 21b and in the fourth double layer 21d, said leg portions occupy the winding zones 23b to 23e in each case. The second current path portion 15b completes a number of full circuits about the stator core 2 along the reference direction RR2, said number corresponding to half of the number of double layers 23a to 21h.

The leg portions 9, 9b, 9f of the third current path portion 15c occupy only half of the number of winding zones 23a to 23h in each double layer 21b to 21d aside from that double layer 21a which comprises the reference layer RL2. In other words, the third current path portion 15c completes a number of full circuits along that circumferential direction 19b which is opposite to the reference direction RR2, said number corresponding to half of the number of double layers 21a to 23h, reduced by one. In that double layer 21a which comprises the reference layer RL2, the leg portions 9, 9b, 9f of the third current path portion 15c occupy a number of winding zones 23a that corresponds to half of the number of winding zones 23a to 23h of the strand U minus the number of winding zones 23b occupied by the leg portions 9, 9a, 9c of the first current path portion 15a.

The circumferential directions 19a, 19b along which the first leg portions 9d, 9f follow the last leg portion 9c, 9e are reversed in relation to the current paths of the first type 14a, 14b. Therefore, in the present exemplary embodiment, in the current paths of the second type 32a, 32b, the first leg portion 9d of the second current path portion 15b follows the last leg portion 9c of the first current path portion 15a along the first circumferential direction 19a, and the first leg portion 9f of the third current path portion 15c follows the last leg portion 9e of the second current path portion 15b along the second circumferential direction 19b.

Otherwise, the statements made regarding the current paths of the first type 14a, 14b are transferable to the current paths of the second type 32a, 32b.

Referring again to FIG. 10, it can be seen that the first outer leg portions 9a of the current paths of the second type 32a, 32b and the second outer leg portions 9b of the current paths of the first type 14a, 14b are situated in the same winding zone 23b. The second outer leg portions 9b of the current paths of the second type 32a, 32b are situated in the other winding zone 23a in relation to the winding zones 23b, 23c in which the outer leg portions 9a, 9b of the current paths of the first type 14a, 14b are arranged.

FIG. 13 is a block circuit diagram of the stator winding 7 of a fourth exemplary embodiment of a stator 1. The fourth exemplary embodiment corresponds to the third exemplary embodiment, aside from the differences described below.

In the fourth exemplary embodiment, the first and second current paths of the first type 14a, 14b of one subset of the strands U, V, W, in this case of the strand U and of the strand W, correspond to those of the third exemplary embodiment. In each of the strands U, W in the fourth exemplary embodiment, a first current path of a third type 33a and a second current path of the third type 33b are provided instead of the first and second current paths of the second type. Furthermore, in another subset of the strands, in this case the strand V, differently designed first and second current paths of the first type 14c, 14d and first and second current paths of the third type 33c, 33d are provided.

In the fourth exemplary embodiment, by way of example, provision is made for the current paths of the first type 14a to 14d and the current paths of the third type 33a to 33d of each one of the strands U, V, W to be connected in parallel, specifically such that, in each strand U, V, W, the first outer leg portions 9a of the first current path of the first type 14a, 14c and of the second current path of the first type 14b, 14d, and also the second outer leg portions 9b of the first current path of the third type 33a, 33c and of the second current path of the third type 33c, are connected to one another and to the corresponding phase connection 16u, 16v, 16w. The second outer leg portions 9b of the first current path of the first type 14a, 14c and of the second current path of the first type 14b, 14d and the first outer leg portions 9a of the first current path of the second type 33a, 33c and of the second current path of the second type 33b, 33d are connected to one another and to the star point 17.

FIG. 14 and FIG. 15 each show a winding pattern of one of the strands U, V, W of the stator winding 7 according to the fourth exemplary embodiment, with FIG. 14 showing the strand U and FIG. 15 showing the strand V.

The strand W is identical to the strand U aside from an offset by N·q+2 slots 6 along the second circumferential direction 19b. This means that the first outer leg portion 9a of the first current path of the first type 14a is arranged in slot number 22 in strand W, and the second outer leg portion 9b of the first current path of the first type 14a is arranged in slot number 16 in strand W. The first outer leg portion 9a of the second current path of the first type 14b is arranged in slot number 21 in strand W, and the second outer leg portion 9b of the second current path of the first type 14b is arranged in slot number 15 in strand W.

The first outer leg portion 9a of the first current path of the third type 33a is arranged in slot number 16 in strand W, and the second outer leg portion 9b of the first current path of the third type 33a is arranged in slot number 22 in strand W. The first outer leg portion 9a of the second current path of the third type 33b is arranged in slot number 15 in strand W, and the second outer leg portion 9b of the second current path of the third type 33b is arranged in slot number 21 in strand W.

FIG. 16 shows a winding pattern of the first current path of the third type 33a of the strand U according to the fourth exemplary embodiment, wherein FIG. 16 shows the current path portions 15a to 15c of the first current path of the third type 33a in separate tables. The statements made regarding the first current path of the third type 33a are thus transferable to the second current path of the third type 33b.

In the current paths of the third type 33a, 32b, the last leg portion 9c of the first current path portion 15a and the first leg portion 9d of the second current path portion 15b are arranged in a reference layer RL3 which is the eighth layer 20h (the L-th layer). The last leg portion 9e of the second current path portion 15b and the first leg portion 9f of the third current path portion 15c are arranged in that layer which is situated radially opposite the reference layer RL3, specifically in the first layer 20a. The outer leg portions 9a, 9b are arranged in that double layer which comprises the reference layer RL3, that is to say in the present case in the fourth double layer 21d (the (L/2)-th double layer).

The leg portions 9, 9d, 9e of the second current path portion 15b occupy immediately adjacent winding zones 23a to 23h of the same strand U from the first leg portion 9d to the last leg portion 9e of the second current path portion 15b along the second circumferential direction 19b as reference direction RR3. The leg portions of the third current path portion 15c occupy immediately adjacent winding zones 23a to 23h of the same strand U from the first leg portion 9e to the last leg portion 9f of the third current path portion 15c along the first circumferential direction 19a, which is opposite to the reference direction RR3.

In the present exemplary embodiment, the first current path portion 15a comprises only one leg portion 9a, 9c, which is arranged in the fourth double layer 21d. This means that, in the current paths of the third type 32a, 32b, the first outer leg portion 9a and the last leg portion 9c of the first current path portion 15a are identical. The number of winding zones 23a to 23h occupied by the first current path portion is thus one in the present case.

The leg portions 9, 9d, 9e of the second current path portion 15b occupy only half of the number of winding zones 23a to 23h in each double layer 21a to 21d. In the first double layer 21a and in the third double layer 21c, said leg portions occupy the winding zones 23a, 23b, 23g, 23h in each case, and in the second double layer 21b and in the fourth double layer 21d, said leg portions occupy the winding zones 23c to 23f in each case. The second current path portion 15b completes a number of full circuits about the stator core 2 along the reference direction RR3, said number corresponding to half of the number of double layers 21a to 21h.

The leg portions 9, 9b, 9f of the third current path portion 15c occupy only half of the number of winding zones 23a to 23h in each double layer 21b to 21d aside from the fourth double layer 21d, which comprises the reference layer RL3. In other words, the third current path portion 15c completes a number of full circuits along that circumferential direction 19b which is opposite to the reference direction RR3, said number corresponding to half of the number of double layers 21a to 23h, reduced by one. In the fourth double layer 21d, which comprises the reference layer RL3, the leg portions 9, 9b, 9f of the third current path portion 15c occupy a number of winding zones 23c to 23e that corresponds to half of the number of winding zones 23a to 23h of the strand U minus the number of winding zones 23b occupied by the leg portions 9, 9a, 9c of the first current path portion 15a.

The circumferential directions 19a, 19b along which the first leg portions 9d, 9f follow the last leg portion 9c, 9e are the same as in the current paths of the first type 14a, 14b. Therefore, in the present exemplary embodiment, in the current paths of the third type 33a, 33b, the first leg portion 9d of the second current path portion 15b follows the last leg portion 9c of the first current path portion 15a along the second circumferential direction 19b, and the first leg portion 9f of the third current path portion 15c follows the last leg portion 9e of the second current path portion 15b along the first circumferential direction 19a.

Otherwise, the statements made regarding the current paths of the first type 14a, 14b are transferable to the current paths of the third type 32a, 32b.

Referring again to FIG. 14, it can be seen that the first outer leg portions 9a of the current paths of the third type 33a, 33b and the second outer leg portions 9b of the current paths of the first type 14a, 14b are situated in the same winding zone 23b. The second outer leg portions 9b of the current paths of the third type 33a, 33b are situated in the same winding zone 23c as the first outer leg portions 9a of the current paths of the first type 14a, 14b.

As can be seen from FIG. 14 and FIG. 15, the current paths of the first type 14c, 14d and the current paths of the third type 33c, 33d of the strand V differ from those of the strand U in that the first current path portions 15a comprise a different number of leg portions 9, 9a, 9c in the strand V than in the strand U. By way of example, in this case, the number of leg portions 9a, 9c of the first current path portions 15a of the current paths of the first type 14c, 14d is one, and the number of leg portions 9, 9a, 9c of the first current path portions 15a of the current paths of the third type 33c, 33d is three. The number of leg portions 9, 9b, 9f of the third current path portions 15c varies accordingly. In the current paths of the first type 14c, 14d of the strand V, the outer leg portion 9a and the last leg portion 9c of the first current path portion 15a are identical.

The outer leg portions 9a, 9b of the current paths 14c, 14d, 33c, 33d of the strand V are offset by four slots 6 along the second circumferential direction 19b in relation to the outer leg portions 9a, 9b of the current paths 14a, 14b, 33a, 33b of the strand U.

In alternative exemplary embodiments in relation to the third exemplary embodiment and in relation to the fourth exemplary embodiment, the first current path portions 15a of the current paths of the second type 32a, 32b and of the current paths of the third type 33a, 33b may also comprise a plurality of leg portions 9, such that the first outer leg portion 9a and the last leg portion 9c of the first current path portion 15a are not identical. In this case, the leg portions 9, 9a, 9c occupy the winding zones 32a, 32b along that circumferential direction 19a, 19b which is opposite to the reference direction RR2, RR3.

FIG. 17 is a block circuit diagram of the stator winding 7 of a fifth exemplary embodiment of a stator 1. All of the statements made regarding the third exemplary embodiment are transferable to the fifth exemplary embodiment, aside from the differences described below.

In the fifth exemplary embodiment, a subset of the strands U, V, W, in this case the strands V, W, has one first current path of the first type 14a and one second current path of the first type 14b in each case. Another subset of the strands U, V, W, in this case the strand U, has one first current path of the second type 32a and one second current path of the second type 32b in each case.

In the present exemplary embodiment, provision is made for the current paths 14a, 14b, 32a, 32b of each one of the strands U, V, W to be connected in series by a connecting portion 11 at the second end side. The series connection is implemented in the strand U by virtue of the second outer leg portion 9b of the first current path of the second type 32a being connected to the first outer leg portion 9a of the second current path of the second type 32b, and in each of the strands V, W by virtue of the first outer leg portion 9a of the second current path of the first type 14b being connected to the second outer leg portion 9b of the first current path of the first type 14a.

For the exemplary interconnection of the strands U, V, Was a star connection, provision is made whereby, in the strand U, the first outer leg portion 9a of the first current path of the second type 32a is connected to the phase connection 16u, and in each of the strands V, W, the second outer leg portion 9b of the second current path of the first type 14b is connected to one of the phase connections 16v, 16w. The second outer leg portion 9b of the second current path of the second type 32b of the strand U, the first outer leg portion 9a of the first current path of the first type 14a of the strand V and the first outer leg portion 9a of the first current path of the first type 14a of the strand W are interconnected to form the star point 17.

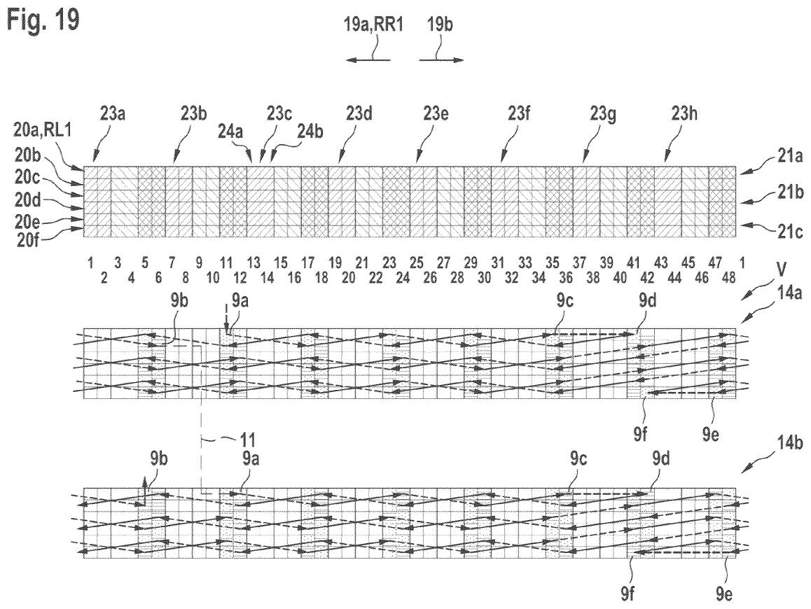

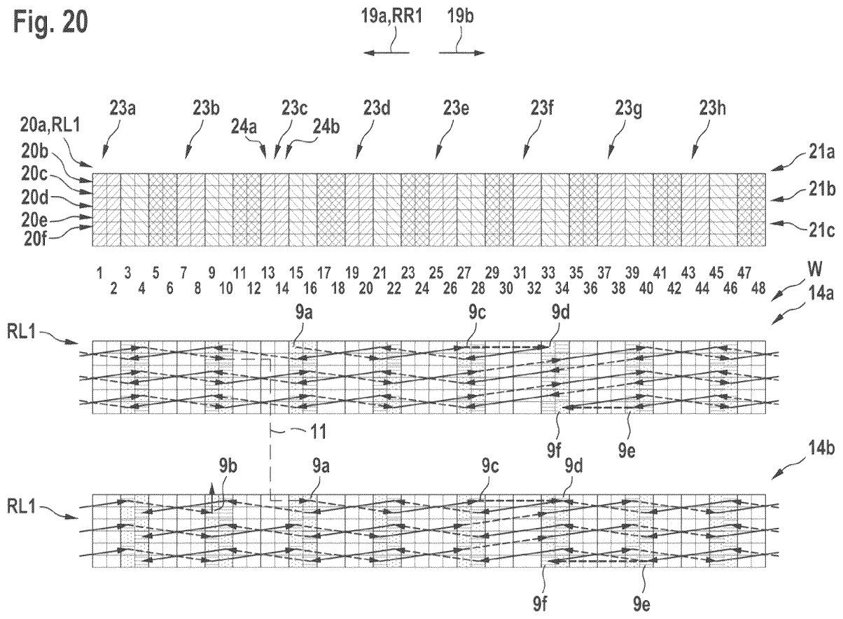

FIG. 18, FIG. 19 and FIG. 20 each show a winding pattern of one of the strands U, V, W of the stator winding 7 according to the fifth exemplary embodiment, with FIG. 18 showing the strand U, FIG. 19 showing the strand V and FIG. 20 showing the strand W.

In the fifth exemplary embodiment, each slot 6 is subdivided radially into L=6 layers 20a to 20f, namely a first layer 20a, a second layer 20b, a third layer 20c, a fourth layer 20d, a fifth layer 20e and a sixth layer 20f. Each slot 6 is accordingly furthermore subdivided into L/2=3 double layers 21a to 21c, wherein the first double layer 21a comprises the first layer 20a and the second layer 20b, the second double layer 21b comprises the third layer 20c and the fourth layer 20d, and the third double layer 21c comprises the fifth layer 20e 34 and the sixth layer 20f. Accordingly, in the fifth exemplary embodiment, 288 receiving spaces are provided.

As can be seen from FIG. 17 to FIG. 20, the first and second outer leg portions 9a, 9b that are connected to the phase connections 16u, 16v, 16w and to the star point 17 are arranged in six winding zones, which are directly successive along the second circumferential direction 19b, of the strands U, V, W.

In the fifth exemplary embodiment, the leg portions 9, 9a, 9c of the first current path portion 15a of the current paths of the first type 14a, 14b and of the current paths of the second type 32a, 32b occupy a different number of winding zones 23a to 23h in each strand U, V, W. In the strand U, the leg portions 9, 9a, 9b of the first current path portion 15a of each one of the current paths of the second type 32a, 32b occupy seven winding zones 23a, 23c to 23h. In the strand V, the leg portions 9, 9a, 9b of the first current path portion 15a of each one of the current paths of the first type 14a, 14b occupy five winding zones. In the strand W, the leg portions 9, 9a, 9b of the first current path portion 15a of each one of the current paths of the first type 14a, 14b occupy three winding zones.

In the fifth exemplary embodiment, the leg portions 9, 9d, 9e of the second current path portion 15b of each one of the current paths of the first type 14a, 14b and of the current paths of the second type 32a, 32b occupy all winding zones 23a to 23h of the corresponding strand U, V, W once.

The leg portions 9, 9b, 9f of the third current path portion 15c of each one of the current paths of the first type 14a, 14b and of the current paths of the second type 32a, 32b occupy each winding zone of the corresponding strand U, V, W once in each double layer 21b, 21c, aside from that double layer 21a which comprises the reference layer RL1, RL2. In that double layer 21a which comprises the reference layer RL1, RL2, the leg portions 9, 9b, 9f of the third current path portion 15c occupy a number of winding zones that corresponds to the number of winding zones 23a to 23h of each one of the strands U, V, W minus the number of winding zones occupied by the leg portions 9, 9a, 9c of the first current path portion 15a. Accordingly, in the strand U, the leg portions 9, 9b, 9f of the third current path portion of each one of the current paths of the second type 32a, 32b occupy one winding zone 23b. In the strand V, the leg portions 9, 9b, 9f of the third current path portion of each one of the current paths of the first type 14a, 14b occupy three winding zones.

In the strand W, the leg portions 9, 9b, 9f of the third current path portion of each one of the current paths of the first type 14a, 14b occupy five winding zones.

In the fifth exemplary embodiment, provision is furthermore made for the leg portions 9, 9a, 9c, 9d, 9e of the first and second current path portions 15a, 15b of each one of the first current paths 14a, 32a to be arranged in the same partial winding zone, in this case in the first partial winding zone 24a. The leg portions 9, 9b, 9f of the third current path portion of each one of the first current paths 14a, 32a are arranged in another partial winding zone, in this case in the second partial winding zone 24b.

In all current paths 14a, 14b, 32a, 32b of each one of the strands U, V, W, the last leg portion 9c of the first current path portion 15a and the first leg portion 9d of the second current path portion 15b are spaced apart from one another by N·q=6 slots. In the strand U, the last leg portion 9e of the second current path portion 15b and the first leg portion 9f of the third current path portion 15c are spaced apart from one another by N·q+1=7 slots in the first current path of the second type 32a and by N·q−1=5 slots in the second current path of the second type 32b. In the strands V, W, the last leg portion 9e of the second current path portion 15b and the first leg portion 9f of the third current path portion 15c are spaced apart from one another by N·q−1=5 slots in the first current path of the first type 14a and by N·q+1=7 slots in the second current path of the first type 14b. The outer leg portions 9a, 9b of the first current paths 14a, 32a of each one of the strands U, V, W are spaced apart from one another by N·q−1=5 slots. The outer leg portions 9a, 9b of the second current paths 14b, 32b of each one of the strands U, V, W are spaced apart from one another by N·q+1=7 slots.

In further exemplary embodiments which otherwise correspond to the first or third to fifth exemplary embodiments, the stator winding 7 is chorded correspondingly to the second exemplary embodiment.

In further exemplary embodiments, the number of layers may also be greater than or less than six or eight. The number of the layers may for example be two, four or ten. The number of slots may also be greater than 48. It is in particular an integer multiple of 2·N·q.

Equally, the number of strands may be greater than or less than three, in particular may be two, four or six.

In further exemplary embodiments that correspond to the exemplary embodiments discussed above, the strands U, V, W are interconnected not as a star connection but as a delta connection.

FIG. 21 shows a schematic diagram of a vehicle 100 having an exemplary embodiment of an electric machine 101.

The electric machine 101, for example a permanently or electrically excited synchronous motor or an asynchronous motor, has a stator 1 according to one of the exemplary embodiments described above, and a rotor 102. The rotor 102 is mounted rotatably with respect to the stator 1.

The vehicle 100 furthermore has wheels 103. The electric machine 101 is configured to drive at least one of the wheels 103 indirectly, for example via a transmission (not shown), or directly, for example in the form of a wheel hub motor. The vehicle 100 may also have an axle (not shown) which is coupled to the wheel 103 and which directly or indirectly drives the electric machine 101 of the vehicle 101.

The vehicle 100 is a battery electric vehicle (BEV), a vehicle operated by means of a fuel cell, or a hybrid vehicle. In the latter case, the vehicle 100 also has an internal combustion engine (not shown).

1. A stator for an electric machine, the stator comprising a stator core which has a longitudinal axis, a first end side, a second end side situated opposite the first end side, and a plurality of slots extending from the first end side to the second end side, and the stator comprising a stator winding which has a number N of strands, wherein N≥2, wherein
a first circumferential direction and a second circumferential direction that is opposite to the first circumferential direction are defined in relation to the longitudinal axis, wherein
each strand is formed by shaped conductors which have leg portions arranged within the slots and form connecting portions which electrically conductively connect in each case two of the leg portions to one another at the end sides, wherein
the slots form, for each strand, a plurality of winding zones, and each slot is subdivided radially into first to L-th layers, which are named according to their order in the radial direction, and L/2 double layers of radially immediately adjacent layers, wherein L≥2 and is an even number, wherein
the stator winding has, for each strand at least one current path, which is formed from a plurality of the leg portions and a plurality of connecting portions which interconnect the leg portions form a series connection, wherein
the at least one current path has a first outer leg portion in relation to the series connection and has a second outer leg portion that is situated opposite the first outer leg portion in relation to the series connection, wherein
the at least one current path has a first current path portion, which comprises the first outer leg portion and one leg portion or a plurality of leg portions which are successive in terms of the series connection, and has a second current path portion and a third current path portion which each comprise a plurality of leg portions which are successive in terms of the series connection, wherein
a last of the leg portions of the first current path portion is connected by means of one of the connecting portions directly to a first of the leg portions of the second current path portion, and a last of the leg portions of the second current path portion is connected by means of one of the connecting portions directly to a first of the leg portions of the third current path portion, wherein
the last leg portion of the first current path portion and the first current path portion of the second current path portion of the at least one current path are arranged in a reference layer which is one out of the first layer and the L-th layer, and the last leg portion of the second current path portion and the first leg portion of the third current path portion of the at least one current path are arranged in the other out of the first layer and the L-th layer, wherein
the outer leg portions of the at least one current path are arranged in that double layer which comprises the reference layer, wherein
the leg portions of the second current path portion occupy immediately adjacent winding zones of the same strand from the first to the last leg portion of the second current path portion along one of the circumferential directions as reference direction, and the leg portions of the third current path portion occupy immediately adjacent winding zones of the same strand proceeding from the first leg portion of the third current path portion along that circumferential direction which is opposite to the reference direction, wherein
one current path is formed as a current path of a first type in which the reference layer is the first layer and the reference direction is the first circumferential direction.

2. The stator as claimed in claim 1, wherein
the last leg portion of the first current path portion and the first leg portion of the second current path portion of the at least one current path are formed by the same shaped conductor, and/or the last leg portion of the second current path portion and the first leg portion of the at least one current path of the third current path portion are formed by the same shaped conductor.

3. The stator as claimed in claim 1, wherein
the leg portion or the leg portions of the first current path portion of the at least one current path occupies or occupy only that double layer which comprises the reference layer, and/or
the leg portions of the second current path portion of the at least one current path occupy each double layer, and/or
the leg portions of the third current path portion of the at least one current path occupy each double layer, and/or
the plurality of leg portions, which are successive in terms of the series connection, of the first current path portion of the at least one current path occupy immediately adjacent winding zones of the same strand along that circumferential direction which is opposite to the reference direction.

4. The stator as claimed in claim 1, wherein
the outer leg portions of the at least one current path are arranged in immediately adjacent winding zones of the same strand and/or in different layers of the same double layer.

5. The stator as claimed in claim 1, wherein
in the current path of the first type,
the first leg portion of the second current path portion follows the last leg portion of the first current path portion along the second circumferential direction, and/or the first leg portion of the third current path portion follows the last leg portion of the second current path portion along the first circumferential direction, or
the first leg portion of the second current path portion follows the last leg portion of the first current path portion along the first circumferential direction, and/or the first leg portion of the third current path portion follows the last leg portion of the second current path portion along the second circumferential direction.

6. The stator as claimed in claim 1, wherein
one current path is formed as a second current path of the first type, wherein the outer leg portions of the current paths of the first type are arranged in the same winding zones.

7. The stator as claimed in claim 6, wherein
one of the outer leg portions of the first current path of the first type connected in series with one of the outer leg portions of the second current path of the first type, or the first current path of the first type and the second current path of the first type are connected in parallel.

8. The stator as claimed in claim 6, wherein
the leg portions of the first current path of the first type and of the second current path of the first type occupy each layer in all winding zones of the same strand, and/or
the leg portions of the second current path portion of each one of the current paths of the first type occupy all winding zones of the same strand in each double layer, and/or
the number of leg portions arranged in that double layer which comprises the reference layer, of the first and third current path portions each one of the current paths of the first type corresponds to the number of winding zones of one of the strands.

9. The stator as claimed in claim 1, wherein
one current path is formed as a current path of a second type, in which the reference layer is the first layer and the reference direction is the first circumferential direction, and
the first leg portion of the second current path portion follows the last leg portion of the first current path portion in the opposite circumferential direction in relation to the current path of the first type, and/or
the first leg portion of the third current path portion follows the first leg portion of the second current path portion in the opposite circumferential direction in relation to the current path of the first type.

10. The stator as claimed in claim 9, wherein
one current path is formed as a second current path of the second type, and
each strand has first and second current paths of the first type and first and second current paths of the second type, or
one subset of the strands has first and second current paths of the first type and one subset of the strands has first and second current paths of the second type.

11. The stator as claimed in claim 1, wherein
one current path is formed as a current path of a third type, in which the reference layer is the L-th layer and the reference direction is the second circumferential direction.

12. The stator as claimed in claim 11, wherein,
in the current path of the third type,
the first leg portion of the second current path portion follows the last leg portion of the first current path portion along the same circumferential direction as in the current path of the first type, and/or the first leg portion of the third current path portion follows the last leg portion of the second current path portion in the same circumferential direction as in the current path of the first type, and/or
the outer leg portions are arranged in the same winding zones as in the current path of the first type.

13. The stator as claimed in claim 11, wherein
one current path is formed as a second current path of the third type, wherein the outer leg portions of the current paths of the third type are arranged in the same winding zones, and/or the number of leg portions of the first current path portion of the current paths of the first type and of the current path of the third type in one subset of the strands differs from that number in another subset of the strands.

14. The stator as claimed in claim 10, wherein
the current paths of the first type and the current paths of the second or third type occupy all winding zones of the same strand, and/or
the leg portions of the second current path portion of each one of the current paths of the first type and of each one of the current paths of the second or third type occupy half of the winding zones in each double layer, and/or
the number of leg portions, arranged in that double layer which comprises the reference layer, of the first and third current path portions of each one of the current paths of the first type and of the current paths of the second or third type corresponds to half of the number of winding zones of one of the strands.

15. The stator as claimed in claim 1, wherein
each shaped conductor integrally forms two of the leg portions and one of the connecting portions provided on the first end side and the connecting portions provided on the second end side are formed by electrically conductive and mechanical, in particular cohesive, connection of two of the shaped conductors, wherein
each one of the outer leg portions of the at least one current path is connected, by one of the connecting portions provided on the first end side, to that leg portion which is directly connected to said outer leg portion by the series connection, and/or
the last leg portion of the first current path portion and the first leg portion of the second current path portion of the at least one current path are connected by one of the connecting portions provided on the first end side, and/or
the last leg portion of the second current path portion and the first leg portion of the third current path portion of the at least one current path are connected by one of the connecting portions provided on the first end side, and/or
the stator furthermore comprises a connection device which contacts at least a subset of the outer shaped conductors of the at least one current path of each one of the strands in order to feed in a multi-phase AC voltage at the second end side, and/or
a pair of first and last leg portions, arranged in the same winding zones and in the same layer, of different current paths are formed a shaped conductor arrangement composed of a first of the shaped conductors, the leg portions of which are spaced apart by a specified number of slots), and a second of the shaped conductors, the leg portions of which are spaced apart by a number of slots that is lower than the specified number, wherein the connecting portion, provided on the first end side, of the second shaped conductor is arranged axially between the stator core and the connecting portion, provided on the first end side of the first shaped conductor, and/or
a pair of first and last leg portions, arranged in the same winding zones and in the same layer, of different current paths are formed a shaped conductor arrangement composed of a first of the shaped conductors, the leg portions of which are spaced apart by a specified number of slots and a second of the shaped conductors, the leg portions of which are spaced apart by a number of slots that is lower than the specified number, wherein the shaped conductors of the shaped conductor arrangement each have two oblique portions which each adjoin one of the leg portions and extend in the axial direction pointing away from the stator core and in the circumferential direction wherein each one of the oblique portions is adjoined by an axial portion which extends further axially away from the stator core than the connecting portions formed by the other shaped conductors, wherein each one of the axial portions is adjoined by a radial portion which covers the other shaped conductors, and the radial portions are connected by a bridge portion which extends along the other shaped conductors in the circumferential direction, wherein the connecting portion of the first shaped conductor borders the connecting portion of the second shaped conductor.

16. The stator as claimed in claim 2, wherein
the leg portion or the leg portions of the first current path portion of the at least one current path occupies or occupy only that double layer which comprises the reference layer, and/or
the leg portions of the second current path portion of the at least one current path occupy each double layer, and/or
the leg portions of the third current path portion of the at least one current path occupy each double layer, and/or
the plurality of leg portions, which are successive in terms of the series connection, of the first current path portion of the at least one current path occupy immediately adjacent winding zones of the same strand along that circumferential direction which is opposite to the reference direction.

17. The stator as claimed in claim 2, wherein
the outer leg portions of the at least one current path are arranged in immediately adjacent winding zones of the same strand and/or in different layers of the same double layer.

18. The stator as claimed in claim 2, wherein
in the current path of the first type,
the first leg portion of the second current path portion follows the last leg portion of the first current path portion along the second circumferential direction, and/or the first leg portion of the third current path portion follows the last leg portion of the second current path portion along the first circumferential direction, or
the first leg portion of the second current path portion follows the last leg portion of the first current path portion along the first circumferential direction, and/or the first leg portion of the third current path portion follows the last leg portion of the second current path portion along the second circumferential direction.

19. The stator as claimed in claim 2, wherein
one current path is formed as a second current path of the first type, wherein the outer leg portions of the current paths of the first type are arranged in the same winding zones.

20. The stator as claimed in claim 7, wherein
the leg portions of the first current path of the first type and of the second current path of the first type occupy each layer in all winding zones of the same strand, and/or
the leg portions of the second current path portion of each one of the current paths of the first type occupy all winding zones of the same strand in each double layer, and/or
the number of leg portions, arranged in that double layer which comprises the reference layer, of the first and third current path portions of each one of the current paths of the first type corresponds to the number of winding zones of one of the strands.
